(19) United States
(12) Patent Application Publication
(10) Pub. No.: US 2026/0002840 A1
(43) Pub. Date: Jan. 1, 2026

(54) TEST RIGS AND METHODS FOR TESTING DUAL-AXLE VEHICLE CORNER SYSTEMS

(71) Applicant: REE AUTOMOTIVE LTD, Galil-Yam (IL)

(72) Inventors: Ran MEIR, Givataim (IL); Shmuel CHIOCLEA, Tel Aviv (IL); Zohar GOLDENSTEIN, Nes-Tziyona (IL); Yossef NOGA, Ashkelon (IL); Lior Shay MERIDOR, Ramat Gan (IL)

(73) Assignee: REE AUTOMOTIVE LTD, Galil-Yam (IL)

(21) Appl. No.: 18/879,004

(22) PCT Filed: Jul. 6, 2023
(86) PCT No.: PCT/IL2023/050708

§ 371 Date: Dec. 26, 2024

Related U.S. Application Data
(60) Provisional application No. 63/358,917, filed on Jul. 7, 2022.

(51) Int. Cl. G01M 17/04

(52) U.S. Cl. CPC G01M 17/045

(57) ABSTRACT

Test rigs for dual-axle vehicle corner systems and methods of testing dual-axle vehicle corner systems are disclosed.

### FIELD OF THE INVENTION

The present invention relates to the field of test rigs for vehicle systems, and more particularly, to test rigs for dual-axle vehicle corner systems.

### BACKGROUND OF THE INVENTION

Vehicle test rigs are used to ensure that vehicle systems (e.g. such as suspension, drivetrain, powertrain and steering systems) operate in accordance with vehicle specifications and standards. Some vehicle test rigs may introduce into the wheel assembly being tested longitudinal forces, side (e.g. lateral) forces, and vertical loads to simulate road surface, braking, and/or steering conditions.

### SUMMARY OF THE INVENTION

Some embodiments of the present invention may provide a test rig for a dual-axle vehicle corner system including a suspension assembly coupled and a first wheel and a second wheel coupled to the suspension assembly, the test rig may include: a support frame to couple the dual-axle vehicle corner system to the test rig; at least one wheel support surface to support the first wheel and the second wheel of the dual-axle vehicle corner system; and at least one actuator to repeatedly move the at least one wheel support surface in a direction that is substantially perpendicular to the at least one wheel support surface to actuate the suspension assembly of the dual-axle vehicle corner system.

In some embodiments, the test rig includes a reference frame, wherein the support frame is coupled to the reference frame and is slidable with respect to the reference frame in the direction that is substantially perpendicular to the at least one wheel support surface.

In some embodiments, the test rig includes a plurality of weights couplable to the support frame.

In some embodiments, the test rig includes at least one rotatable member mounted within the at least one wheel support surface, the at least one rotatable member to support the first wheel and the second wheel of the dual-axle vehicle corner system while the first wheel and the second wheel are spinning.

In some embodiments, the test rig includes at least one motor to rotate the at least one rotatable member in a direction that is opposite to direction of rotation of the first wheel and the second wheel to resist operation of a powertrain assembly of the dual-axle vehicle corner system.

In some embodiments, the test rig includes at least one motor to rotate the at least one rotatable member to cause the first wheel and the second wheel the dual-axle vehicle corner system to spin.

In some embodiments, the at least one wheel support surface is rotatable about a rotation axis that is substantially perpendicular to the at least one wheel support surface, and the test rig includes at least one motor to rotate the at least one wheel support surface.

In some embodiments, the test rig includes a computing device to, based on signals from at least one of sensors of the dual-axle vehicle corner system or sensors of the test rig, determine whether or not subsystems of the dual-axle vehicle corner system are at least one of tuned and operate according to predefined specifications.

In some embodiments, the computing device to calibrate the sensors of the of the dual-axle vehicle corner system based on signals from the sensors of the test rig.

In some embodiments, the at least one actuator is to repeatedly move the at least one wheel support surface in a direction that is substantially perpendicular to the support frame and substantially parallel to the at least one wheel support surface.

In some embodiments, the at least one actuator is to repeatedly move the at least one wheel support surface in a direction that is substantially parallel to the support frame and to the at least one wheel support surface.

In some embodiments, the at least one actuator is to incline the at least one wheel support surface about an axis being parallel to a direction that is substantially perpendicular to the support frame and substantially parallel to the at least one wheel support surface.

In some embodiments, the at least one actuator is to incline the at least one wheel support surface about an axis being parallel to a direction that is substantially parallel to the support frame and to the at least one wheel support surface.

In some embodiments, a relative position and orientation between the support frame and the at least one wheel support surface is adjustable.

In some embodiments, a relative position and orientation between the support frame and the at least one wheel support surface is adjustable during operation of the test rig.

In some embodiments, a relative position and orientation between the support frame and the at least one wheel support surface is adjustable prior to operation of the test rig.

In some embodiments, the at least one wheel support surface includes a first wheel support surface to support the first wheel of the dual-axle vehicle corner system and a second wheel support surface to support the second wheel of the dual-axle vehicle corner system.

In some embodiments, the at least one actuator is to repeatedly move the first wheel support surface and the second wheel support surface in a direction that is substantially perpendicular to the support frame and substantially parallel to the wheel support surfaces.

In some embodiments, the at least one actuator is to repeatedly move the first wheel support surface and the second wheel support surface in a direction that is substantially parallel to the support frame and to the wheel support surfaces.

In some embodiments, the at least one actuator is to incline the first wheel support surface and the second wheel support surface about an axis being parallel to a direction that is substantially perpendicular to the support frame and substantially parallel to the wheel support surfaces.

In some embodiments, the at least one actuator is to incline the first wheel support surface and the second wheel support surface about an axis being parallel to a direction that is substantially parallel to the support frame and to the wheel support surfaces.

In some embodiments, the test rig includes a computing device to control a steering assembly of the dual-axle vehicle corner system to cause at least one of the first wheel and the second wheel to steer about their respective steering axes during actuating of the suspension assembly.

Some embodiments of the present invention may provide a test rig or a dual-axle vehicle corner system including a suspension assembly and a first wheel and a second wheel coupled to the suspension assembly, the test rig may include: a support frame to couple the dual-axle vehicle corner system to the test rig; a wheel support surface to support the first wheel and the second wheel of the dual-axle vehicle corner system; and at least one actuator to repeatedly move the support frame in a direction that is substantially perpendicular to the wheel support surface to actuate the suspension assembly of the dual-axle vehicle corner system.

In some embodiments, the at least one actuator is to repeatedly move the support frame in a direction that is substantially perpendicular to the support frame and substantially parallel to the wheels support surface.

In some embodiments, the at least one is to repeatedly move the support frame in a direction that is substantially parallel to the support frame and to the wheels support surface.

In some embodiments, the at least one actuator is to incline the support frame about an axis being parallel to a direction that is substantially perpendicular to the support frame and substantially parallel to the wheels support surface.

In some embodiments, the at least one actuator is to incline the support frame about an axis being parallel to a direction that is substantially parallel to the support frame and to the wheels support surface.

In some embodiments, the test rig includes a reference frame, wherein the frame is coupled to the reference frame and is slidable with respect to the reference frame in one or more directions.

In some embodiments, the test rig includes a plurality of weights couplable to the support frame.

In some embodiments, the test rig includes at least one rotatable member mounted within the at least one wheel support surface, the at least one rotatable member is to support the first wheel and the second wheel of the dual-axle vehicle corner system while the first wheel and the second wheel are spinning.

In some embodiments, the test rig includes at least one motor to rotate the at least one rotatable member in a direction that is opposite to direction of rotation of the first wheel and the second wheel to resist operation of a powertrain assembly of the dual-axle vehicle corner system.

In some embodiments, the test rig includes at least one motor to rotate the at least one rotatable member to cause the first wheel and the second wheel the dual-axle vehicle corner system to spin.

In some embodiments, the at least one wheel support surface is rotatable about a rotation axis that is substantially perpendicular to the at least one wheel support surface, and the test rig includes at least one motor to rotate the at least one wheel support surface.

In some embodiments, the test rig includes a computing device to, based on signals from at least one of sensors of the dual-axle vehicle corner system or sensors of the test rig, determine whether or not subsystems of the dual-axle vehicle corner system are at least one of tuned and operate according to predefined specifications.

In some embodiments, the computing device to calibrate the sensors of the of the dual-axle vehicle corner system based on signals from the sensors of the test rig.

In some embodiments, the test rig includes a computing device to control a steering assembly of the dual-axle vehicle corner system to cause at least one of the first wheel and the second wheel to steer about their respective steering axes during actuating of the suspension assembly.

Some embodiments of the present invention may provide a test rig or a dual-axle vehicle corner system including a suspension assembly, a first wheel and a second wheel coupled to the suspension assembly, and a powertrain assembly including a powertrain motor to spin the first wheel and the second wheel, the test rig may include: a support frame to couple the dual-axle vehicle corner system to the test rig; and at least one rotatable member to support the first wheel and the second wheel of the dual-axle vehicle corner system while the first wheel and the second wheel are spinning.

In some embodiments, the test rig includes at least one motor to rotate the at least one rotatable member in a direction that is opposite to direction of rotation of the first wheel and the second wheel to resist operation of the powertrain motor of the powertrain assembly of the dual-axle vehicle corner system.

In some embodiments, the test rig includes at least one motor to rotate the at least one rotatable member to cause of the first wheel and the second wheel to spin to actuate regeneration functionality of the powertrain motor of the powertrain assembly of the dual-axle vehicle corner system.

In some embodiments, the at least one rotatable member is mounted within at least one wheel support surface, and the test rig includes at least one actuator to repeatedly move the at least one wheel support surface in a direction that is substantially perpendicular to the at least one wheel support surface to actuate the suspension assembly of the dual-axle vehicle corner system.

In some embodiments, the at least one rotatable member is mounted within at least one wheel support surface, the at least one wheel support surface is rotatable about a rotation axis that is substantially perpendicular to the at least one wheel support surface, and the test rig includes at least one motor to rotate the at least one wheel support surface.

In some embodiments, the test rig includes a computing device to, based on signals from at least one of sensors of the dual-axle vehicle corner system or sensors of the test rig, determine whether or not subsystems of the dual-axle vehicle corner system are at least one of tuned and operate according to predefined specifications.

In some embodiments, the computing device to calibrate the sensors of the of the dual-axle vehicle corner system based on signals from the sensors of the test rig.

In some embodiments, the test rig includes a computing device to control a steering assembly of the dual-axle vehicle corner system to cause at least one of the first wheel and the second wheel to steer about their respective steering axes.

Some embodiments of the present invention may provide a test rig or a dual-axle vehicle corner system including a suspension assembly and a first wheel and a second wheel coupled to the suspension assembly, the test rig may include: a support frame to couple the sub-frame of the dual-axle vehicle corner system to the test rig; at least one rotatable member to support and cause the first wheel and the second wheel of the dual-axle vehicle corner system to spin; and at least one motor to rotate the at least one rotatable member.

In some embodiments, the at least one rotatable member is mounted within at least one wheel support surface, and the test rig includes at least one actuator to repeatedly move the at least one wheel support surface in a direction that is substantially perpendicular to the at least one wheel support surface to actuate the suspension assembly of the dual-axle vehicle corner system.

In some embodiments, the at least one rotatable member is mounted within at least one wheel support surface, the at least one wheel support surface is rotatable about a rotation axis that is substantially perpendicular to the at least one wheel support surface, and the test rig includes at least one motor to rotate the at least one wheel support surface.

In some embodiments, the test rig includes a computing device to, based on signals from at least one of sensors of the dual-axle vehicle corner system or sensors of the test rig, determine whether or not subsystems of the dual-axle vehicle corner system are at least one of tuned and operate according to predefined specifications.

In some embodiments, the computing device to calibrate the sensors of the of the dual-axle vehicle corner system based on signals from the sensors of the test rig.

In some embodiments, the test rig includes a computing device to control a steering assembly of the dual-axle vehicle corner system to cause at least one of the first wheel and the second wheel to steer about their respective steering axes.

Some embodiments of the present invention may provide a test rig or a dual-axle vehicle corner system including a suspension assembly, a first wheel and a second wheel coupled to the suspension assembly, and a steering assembly to steer the first wheel and the second wheel, the test rig may include: a support frame to couple the dual-axle vehicle corner system to the test rig; at least one wheel support surface to support the first wheel and the second wheel of the dual-axle vehicle corner system, the at least one wheel support surface being rotatable about a rotation axis that is substantially perpendicular to the at least one wheel support surface; and at least one motor to rotate the at least one wheel support surface to actuate the steering assembly of the dual-axle vehicle system.

In some embodiments, the test rig includes at least one actuator to repeatedly move the at least one wheel support surface in a direction that is substantially perpendicular to the at least one wheel support surface to actuate the suspension assembly of the dual-axle vehicle corner system.

In some embodiments, the test rig includes at least one rotatable member mounted within the at least one wheel support surface, the at least one rotatable member to support the first wheel and the second wheel of the dual-axle vehicle corner system while the first wheel and the second wheel are spinning.

In some embodiments, the test rig includes at least one motor to rotate the at least one rotatable member in a direction that is opposite to direction of rotation of the first wheel and the second wheel to resist operation of a powertrain assembly of the dual-axle vehicle corner system.

In some embodiments, the test rig includes at least one motor to rotate the at least one rotatable member to cause the first wheel and the second wheel the dual-axle vehicle corner system to spin.

In some embodiments, the test rig includes a computing device to, based on signals from at least one of sensors of the dual-axle vehicle corner system or sensors of the test rig, determine whether or not subsystems of the dual-axle vehicle corner system are at least one of tuned and operate according to predefined specifications

In some embodiments, the computing device to calibrate the sensors of the of the dual-axle vehicle corner system based on signals from the sensors of the test rig.

Some embodiments of the present invention may provide a method of testing a dual-axle vehicle corner system including a suspension assembly and a first wheel and a second wheel coupled to the suspension assembly, the method may include: coupling the dual-axle vehicle corner system to a test rig; and by the test rig, repeatedly actuating the suspension assembly of the dual-axle vehicle corner system a vertical direction, the vertical direction being perpendicular to spinning axes of the first wheel and the second wheel coupled the suspension assembly.

In some embodiments, the actuating of the suspension assembly is by repeatedly causing motion of at least one of the first wheel and the second wheel in the vertical direction with respect to a sub-frame of the dual-axle vehicle corner system.

In some embodiments, the actuating of the suspension assembly is by causing motion of a sub-frame of the dual-axle vehicle corner system with respect to at least one of the first wheel and the second wheel in the vertical direction.

In some embodiments, the actuating of the suspension assembly is further by repeatedly causing motion of at least one of the first wheel, the second wheel and a sub-frame of the dual-axle vehicle corner system in directions that are transverse to the vertical direction.

In some embodiments, the actuating of the suspension assembly is further by inclining a support frame of the test rig coupled to the dual-axle vehicle corner system with respect to at least one wheel support surface of the test rig supporting the first wheel and the second wheel.

In some embodiments, the inclining is about an axis that is substantially transverse to the spinning axes of the first wheel and the second wheel.

In some embodiments, the inclining is about an axis that is substantially parallel to the spinning axes of the first wheel and the second wheel.

In some embodiments, the method includes adjusting a weight of the dual-axle vehicle corner system by coupling a plurality of weights to the dual-axle vehicle corner system.

In some embodiments, the coupling of the plurality of weights is to a component of the test rig to which the dual-axle vehicle corner system is coupled.

In some embodiments, the method includes, by the test rig, causing the first wheel and the second wheel to spin.

In some embodiments, the method includes: by the test rig, controlling a powertrain assembly of the dual-axle vehicle corner system to cause at least one of the first wheel and the second wheel to spin; and by the test rig, resisting operation of the powertrain assembly by applying a rotational force on at least one of the first wheel and the second wheel in a direction that is opposite to direction of spinning of the first wheel and the second wheel.

In some embodiments, the method includes by the test rig, actuating a steering assembly of the dual-axle vehicle corner system by causing the first wheel, the second wheel or both to repeatedly rotate about their respective steering axes that are substantially parallel to the spinning axes of the first wheel and the second wheel.

In some embodiments, the method includes, by the test rig, controlling a steering assembly of the dual-axle vehicle corner system to cause at least one of the first wheel and the second wheel to steer about their respective steering axes during actuating of the suspension assembly.

In some embodiments, the method includes, by a computing device, based on signals from at least one of sensors of the dual-axle vehicle corner system or sensors of the test rig, determining whether or not subsystems of the dual-axle vehicle corner system are at least one of tuned and operate according to predefined specifications.

In some embodiments, the method includes, by the computing device, calibrating the sensors of the of the dual-axle vehicle corner system based on signals from the sensors of the test rig.

Some embodiments of the present invention may provide a method of testing a dual-axle vehicle corner system including a suspension assembly, a first wheel and a second wheel coupled to the suspension assembly, and a powertrain assembly including a powertrain motor to spin the first wheel and the second wheel, the method may include: coupling the dual-axle vehicle corner system to a test rig; by the test rig, controlling the powertrain assembly to cause the first wheel, the second wheel or both to spin about their respective spinning axes; and by the test rig, resisting operation of the powertrain assembly by applying a rotational force on the first wheel and the second wheel in a direction that is opposite to direction of spinning of the first wheel and the second wheel.

In some embodiments, the method includes: by the test rig, causing of the first wheel and the second wheel to spin to actuate regeneration functionality of the powertrain motor of the powertrain assembly of the dual-axle vehicle corner system.

In some embodiments, the method includes: by the test rig, actuating the suspension assembly of the dual-axle vehicle corner system by repeatedly causing motion of at least one of the first wheel, the second wheel and a sub-frame of the dual-axle vehicle corner system in at least one of: a vertical direction being perpendicular to the spinning axes of the first wheel and the second wheel and in directions that are transverse to the vertical direction.

In some embodiments, the actuating of the suspension assembly is further by inclining a support frame of the test rig coupled to the dual-axle vehicle corner system with respect to at least one wheel support surface of the test rig supporting the first wheel and the second wheel about at least one of: an axis that is substantially transverse to the spinning axes of the first wheel and the second wheel and an axis that is substantially parallel to the spinning axes of the first wheel and the second wheel.

In some embodiments, the method includes adjusting a weight of the dual-axle vehicle corner system by coupling a plurality of weights to the dual-axle vehicle corner system.

In some embodiments, the method includes, by the test rig, actuating a steering assembly of the dual-axle vehicle corner system by causing the first wheel, the second wheel or both to repeatedly rotate about their respective steering axes that are substantially parallel to the spinning axes of the first wheel and the second wheel.

In some embodiments, the method includes: by the test rig, controlling a steering assembly of the dual-axle vehicle corner system to cause at least one of the first wheel and the second wheel to steer about their respective steering axes.

In some embodiments, the method includes, by a computing device, based on signals from at least one of sensors of the dual-axle vehicle corner system or sensors of the test rig, determining whether or not subsystems of the dual-axle vehicle corner system are at least one of tuned and operate according to predefined specifications.

In some embodiments, the method includes, by the computing device, calibrating the sensors of the of the dual-axle vehicle corner system based on signals from the sensors of the test rig.

Some embodiments of the present invention may provide method of testing a dual-axle vehicle corner system including a suspension assembly, a first wheel and a second wheel coupled to the suspension assembly, and a steering assembly to steer the first wheel and the second wheel, the method may include: coupling the dual-axle vehicle corner system to a test rig; and by the test rig, actuating a steering assembly of the dual-axle vehicle corner system by causing the first wheel, the second wheel or both to repeatedly rotate about their respective steering axes that are substantially parallel to their respective spinning axes.

In some embodiments, the method includes: by the test rig, actuating the suspension assembly of the dual-axle vehicle corner system by repeatedly causing motion of at least one of the first wheel, the second wheel and a sub-frame of the dual-axle vehicle corner system the suspension assembly in at least one of: a vertical direction being perpendicular to the spinning axes of the first wheel and the second wheel and in directions that are transverse to the vertical direction.

In some embodiments, the actuating of the suspension assembly is further by inclining a support frame of the test rig coupled to the dual-axle vehicle corner system with respect to at least one wheel support surface of the test rig supporting the first wheel and the second wheel about at least one of: an axis that is substantially transverse to the spinning axes of the first wheel and the second wheel and an axis that is substantially parallel to the spinning axes of the first wheel and the second wheel.

In some embodiments, the method includes adjusting a weight of the dual-axle vehicle corner system by coupling a plurality of weights to the dual-axle vehicle corner system.

In some embodiments, the method includes, by the test rig, causing the first wheel and the second wheel to spin.

In some embodiments, the method includes: by the test rig, controlling a powertrain assembly of the dual-axle vehicle corner system to cause at least one of the first wheel and the second wheel to spin; and by the test rig, resisting operation of the powertrain assembly by applying a rotational force on at least one of the first wheel and the second wheel in a direction that is opposite to direction of spinning of the first wheel and the second wheel.

In some embodiments, the method includes, by a computing device, based on signals from at least one of sensors of the dual-axle vehicle corner system or sensors of the test rig, determining whether or not subsystems of the dual-axle vehicle corner system are at least one of tuned and operate according to predefined specifications.

In some embodiments, the method includes, by the computing device, calibrating the sensors of the of the dual-axle vehicle corner system based on signals from the sensors of the test rig.

Some embodiments of the present invention may provide a method of testing a dual-axle vehicle corner system including a suspension assembly and a first wheel and a second wheel coupled to the suspension assembly, the method may include: coupling the dual-axle vehicle corner system to a test rig; and by the test rig, causing the first wheel, the second wheel or both to spin about their respective spinning axes.

In some embodiments, the method includes, by the test rig, actuating the suspension assembly of the dual-axle vehicle corner system by repeatedly causing motion of at least one of the first wheel, the second wheel and a sub-frame of the dual-axle vehicle corner system in at least one of: a vertical direction being perpendicular to the spinning axes of the first wheel and the second wheel and in directions that are transverse to the vertical direction.

In some embodiments, the actuating of the suspension assembly is further by inclining a support frame of the test rig coupled to the dual-axle vehicle corner system with respect to at least one wheel support surface of the test rig supporting the first wheel and the second wheel about at least one of: an axis that is substantially transverse to the spinning axes of the first wheel and the second wheel and an axis that is substantially parallel to the spinning axes of the first wheel and the second wheel.

In some embodiments, the method includes adjusting a weight of the dual-axle vehicle corner system by coupling a plurality of weights to the dual-axle vehicle corner system.

In some embodiments, the method includes, by the test rig, actuating a steering assembly of the dual-axle vehicle corner system by causing the first wheel, the second wheel or both to repeatedly rotate about their respective steering axes that are substantially parallel to the spinning axes of the first wheel and the second wheel.

In some embodiments, the method includes: by the test rig, controlling a steering assembly of the dual-axle vehicle corner system to cause at least one of the first wheel and the second wheel to steer about their respective steering axes.

In some embodiments, the method includes, by a computing device, based on signals from at least one of sensors of the dual-axle vehicle corner system or sensors of the test rig, determining whether or not subsystems of the dual-axle vehicle corner system are at least one of tuned and operate according to predefined specifications.

In some embodiments, the method includes, by the computing device, calibrating the sensors of the of the dual-axle vehicle corner system based on signals from the sensors of the test rig.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout. In the accompanying drawings:

FIGS. 1A and 1B are schematic illustrations of a test rig including a wheel support surface, and of a dual-axle vehicle corner system coupled to the test rig, according to some embodiments of the invention;

FIG. 1C is a schematic illustration of test rig 100 including two wheel support surfaces, and of the dual-axle vehicle corner system coupled to the test rig, according to some embodiments of the invention;

FIGS. 2A and 2B are schematic illustrations of a test rig including one or more actuators to repeatedly move a frame of the test rig, and of the dual-axle vehicle corner system coupled to the test rig, according to some embodiments of the invention;

FIGS. 3A and 3B are schematic illustrations of a test rig including rollers to rotatably support wheels of the dual-axle vehicle corner system, and of the dual-axle vehicle corner system coupled to the test rig, according to some embodiments of the invention;

FIGS. 4A and 4B are schematic illustrations of a test rig including rollers to rotatably support and cause wheels of the dual-axle vehicle corner system to spin, and of the dual-axle vehicle corner system coupled to the test rig, according to some embodiments of the invention;

FIGS. 5A and 5B are schematic illustrations of a test rig including a rotatable wheel support surface, and of the dual-axle vehicle corner system coupled to the test rig, according to some embodiments of the invention;

FIGS. 5C and 5D is a schematic illustration of the test rig including two rotatable wheel support surfaces, and of the dual-axle vehicle corner system coupled to the test rig, according to some embodiments of the invention;

FIG. 6 is a three-dimensional (3D) diagram of a test rig and of the dual-axle vehicle corner system coupled to the test rig, according to some embodiments of the invention;

FIG. 7 is a flowchart of a method of testing a dual-axle vehicle corner system including a suspension assembly, according to some embodiments of the invention;

FIG. 8 is a flowchart of a method of testing a dual-axle vehicle corner system including a powertrain assembly, according to some embodiments of the invention;

FIG. 9 is a flowchart of a method of testing a dual-axle vehicle corner system including a drivetrain assembly, according to some embodiments of the invention;

FIG. 10 is a flowchart of a method of testing a dual-axle vehicle corner system including a steering assembly, according to some embodiments of the invention; and

FIG. 11 is a flowchart of a method of testing a dual-axle vehicle corner system, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention can be practiced without the specific details presented herein. Furthermore, well known features can have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention can be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

Embodiments of the present invention may provide a test rig (e.g. a quarter vehicle test rig) for a dual-axle vehicle corner system. The test rig may include a frame to couple components of the dual-axle vehicle corner system to the test reg. The test rig may include at least one wheel support surface to support the wheels of the dual-axle vehicle corner system. The test rig may include at least one rotatable member (e.g. such as one or more rollers), e.g. mounted within the at least one wheel support surface, to support the wheels of the dual-axle vehicle corner system while the wheels are spinning (e.g. rotating about their respective wheel rotation axes) and/or to cause the wheels to spin. The at least one wheel support surface may be rotatable (e.g. steerable) about an axis that is substantially perpendicular to the at least one wheel support surface. The test rig may include actuators to actuate (e.g. repeatedly actuate) various assemblies or subsystems of the dual-axle vehicle corner system (e.g. such as suspension assembly, drivetrain assembly, powertrain assembly, steering assembly or any other suitable assembly or subsystem of the dual-axle vehicle corner system) to determine whether or not the assemblies or subsystems operate in accordance with predefined specifications.

The following illustrations/description describe embodiments of test rigs for dual-axle vehicle corner systems. Each of these embodiments may include features from other embodiments presented, and embodiments not specifically described may include various features described herein.

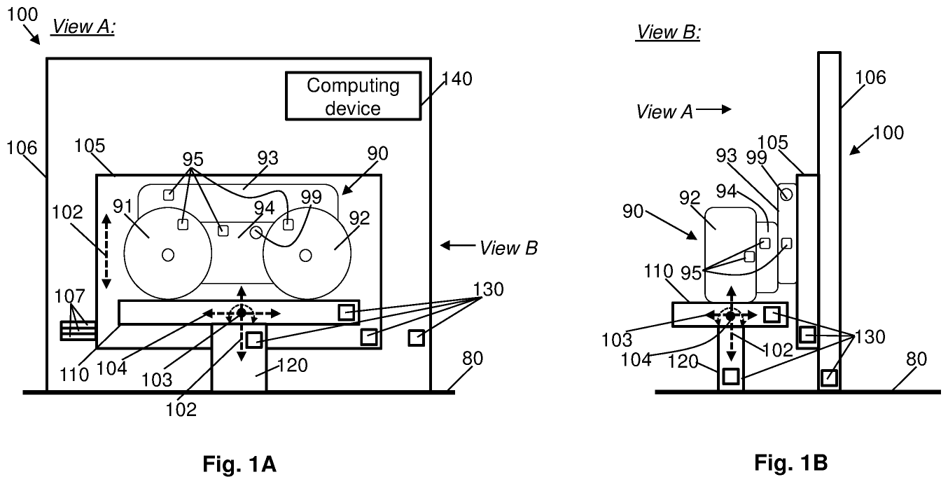

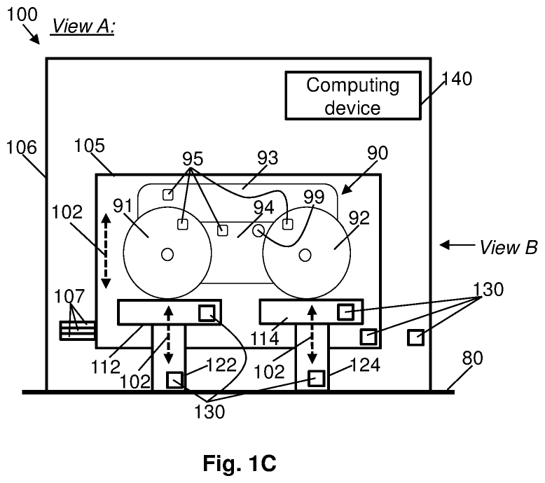

Reference is now made to FIGS. 1A and 1B, which are schematic illustrations of a test rig 100 including a wheel support surface 110, and of a dual-axle vehicle corner system 90 coupled to test rig 100, according to some embodiments of the invention.

Test rig 100 may include a support frame 105, a wheel support surface 110 and an actuator 120.

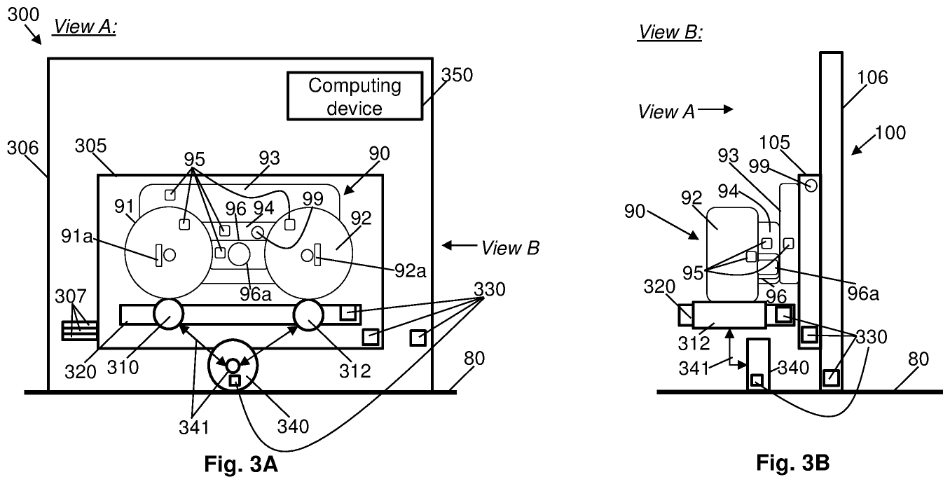

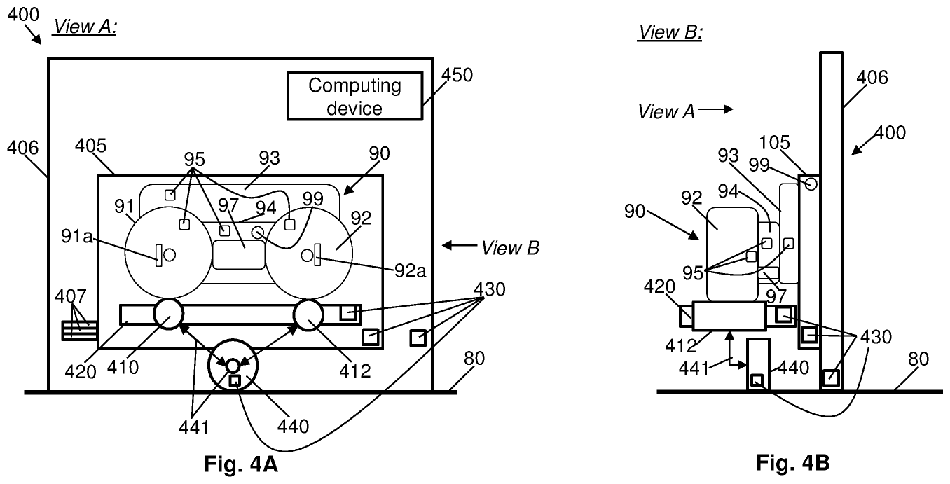

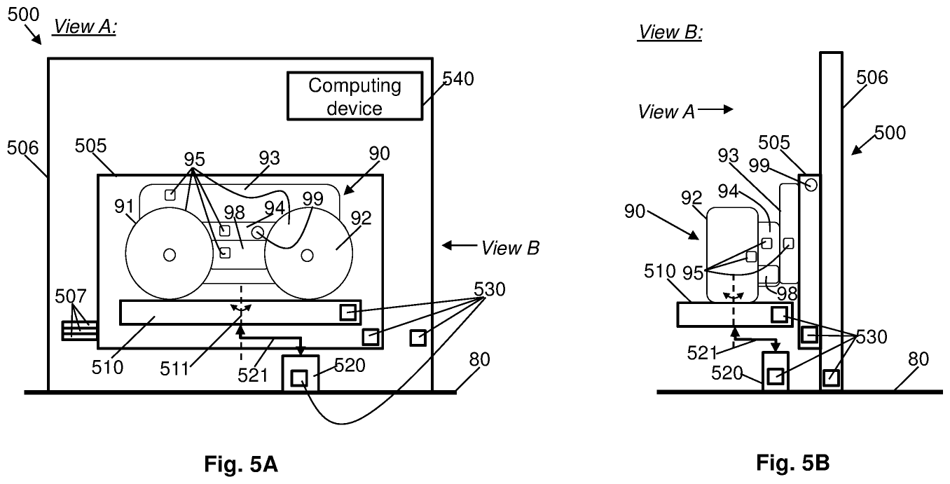

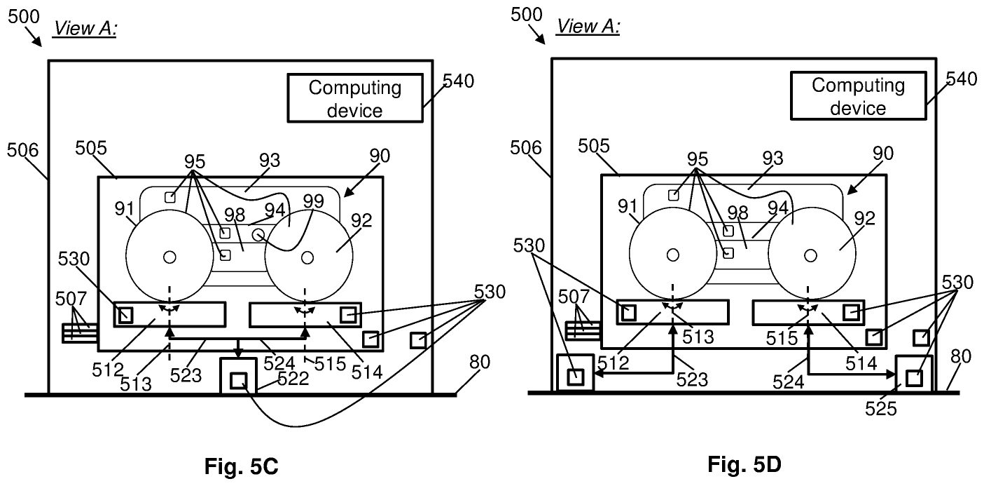

Support frame 105 may couple components of dual-axle vehicle corner system 90 to test rig 100. In the examples described herein, support frame 105 couples a sub-frame 93 of dual-axle vehicle corner system 90 to test rig 100. Sub-frame 93 of dual-axle vehicle corner system 90 may support various assemblies or sub-systems of dual-axle vehicle corner system 90, such as a suspension assembly 94 as shown in FIGS. 1A and 1B. Sub-frame 93 may support assemblies or subsystems other than suspension assembly 94. For example, sub-frame 93 may support, a powertrain assembly 96 (e.g. as described with respect to FIGS. 3A, 3B), a drivetrain assembly 97 (e.g. as described with respect to FIGS. 4A, 4B) and/or a steering assembly 98 (e.g. as described with respect to FIGS. 5A, 5B, 5C and 5D). Some dual-axle vehicle corner systems have no sub-frame and components of these dual-axle vehicle corner systems may be coupled (e.g. directly coupled) to support frame 105 of test rig 100. Dual-axle vehicle corner system 90 may include a first wheel 91 and a second wheel 92 coupled to suspension assembly 94 of dual-axle vehicle corner system 90. Dual-axle vehicle corner system 90 may include sensors 95. First wheel 91, second wheel 92, sub-frame 93 and/or suspension assembly 94 may each include one or more of sensors 95. Sensors 95 may, for example, include accelerometers, rotational sensors and/or any other suitable sensors that may measure parameters related to operation of various assemblies or subsystems of dual-axle vehicle corner system 90.

Coupling of dual-axle vehicle corner system 90 to support frame 105 of test rig 100 may be rigid. The rigid coupling of dual-axle vehicle corner system 90 to support frame 105 may restrict movement of components of dual-axle vehicle corner system 90 (e.g., such as sub-frame 93 or other components of dual-axle vehicle corner system 90 as described hereinabove) with respect to support frame 105.

Coupling of dual-axle vehicle corner system 90 to support frame 105 of test rig 100 may allow (or at least partly allow) one or more degrees of freedom of between components of dual-axle vehicle corner system 90 (e.g., such as sub-frame 93 or other components of dual-axle vehicle corner system 90 as described hereinabove) with respect to support frame 105. The one or more degrees of freedom may, for example, include rotation (e.g., steering), linear vertical movement, linear transverse movement and/or any other suitable degree of freedom of components of dual- axle vehicle corner system 90 with respect to support frame 105.

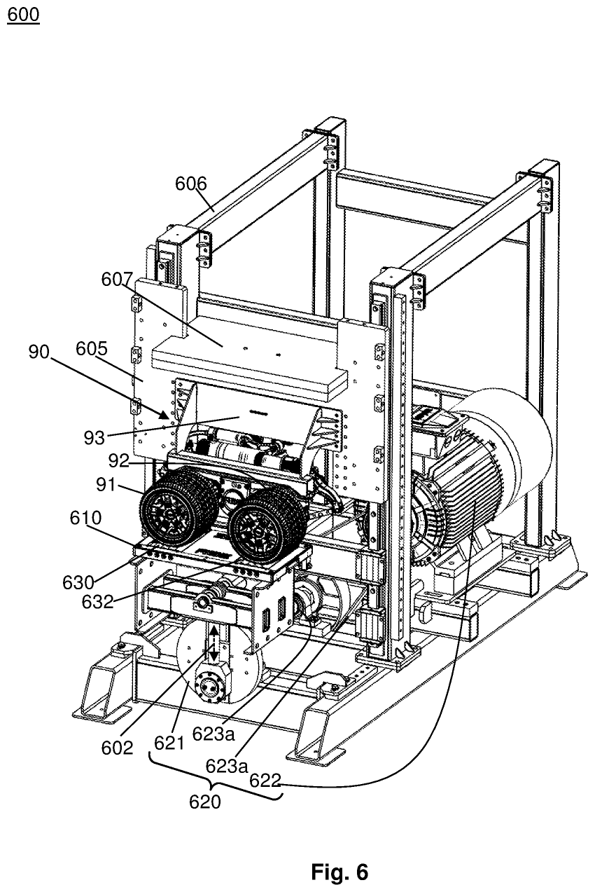

Test rig 100 may include a reference frame 106. Reference frame 106 may be disposed on a surface 80 (e.g. the ground). Support frame 105 (e.g. coupling dual-axle vehicle corner system 100 to test rig 100) may be coupled to reference frame 106 and may be slidable with respect to reference frame 106. Support frame 105 may be slidable with respect to reference frame 106 in one or more directions. For example, support frame 105 may be slidable with respect to reference frame 106 in a vertical direction 102 that is perpendicular (or substantially perpendicular) to surface 80. In operation, support frame 105 may, for example, represent a reference frame of a vehicle (e.g. chassis) to which dual-axle vehicle corner system may be attached. For example, a plurality of different weights 107 may be coupled to support frame 105 to represent different loads being carried by the chassis of the vehicle represented by support frame 105. Weights 107 may be coupled to support frame 105 at a side portion of support frame 105 (e.g., as shown in FIG. 1A), an upper portion of support frame 105 (e.g., as shown in FIG. 6), a bottom portion of support frame 105 and/or at any other suitable position.

Wheel support surface 110 may be transverse, e.g. perpendicular (or substantially perpendicular), to support frame 105. Wheel support surface 110 may support first wheel 91 and second wheel 92 of dual-axle vehicle corner system 90. In operation, wheel support surface 110 may represent a surface of the road.

Test rig 100 may have one or more degrees of freedom (e.g. defined by degrees of freedom between support frame 105 and wheel support surface 110) to represent motion and/or loads in one or more of vertical, lateral, and longitudinal directions between the reference frame of the vehicle (e.g. the chassis), the road surface and/or components of dual-axle vehicle corner system 90 (e.g. as described hereinbelow).

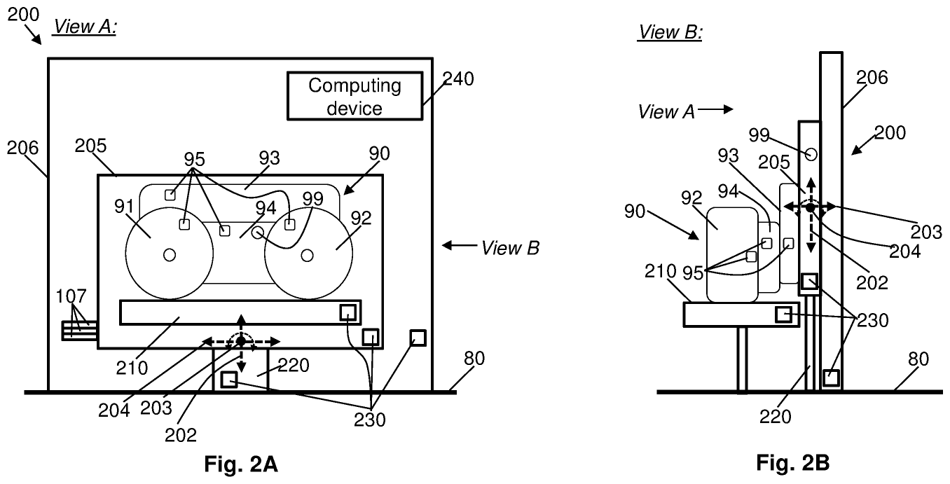

For example, actuator 120 may repeatedly move wheel support surface 110 in direction 102 that is perpendicular (or substantially perpendicular) to wheel support surface 110. Repeated motion of wheel support surface 110 by actuator 120 may, for example, actuate suspension assembly 94 of dual-axle vehicle corner system 90. Actuator 120 may, for example, include a linear actuator, a vibrational actuator, a circular eccentric cam (e.g. as described below with respect to FIG. 6) or any other suitable actuator that may cause repeated motion of wheel support surface 110. Actuator 120 or an additional dedicated actuator of test rig 100 may, for example, repeatedly move wheel support surface 110 in a direction 103 that is perpendicular (or substantially perpendicular) to support frame 105 and parallel (or substantially parallel) to wheels support surface 110. Actuator 120 or an additional dedicated actuator may, for example, repeatedly move wheel support surface 110 in a direction 104 that is parallel (or substantially parallel) to support frame 105 and to wheels support surface 110. Actuator 120 or an additional dedicated actuator of test rig 100 may, for example, incline (e.g. repeatedly incline) wheel support surface 110 about an axis being parallel to direction 103 that is perpendicular (or substantially perpendicular) to support frame 105 and parallel (or substantially parallel) to wheels support surface 110. Actuator 120 or an additional dedicated actuator of test rig 100 may, for example, incline (e.g. repeatedly incline) wheel support surface 110 about an axis being parallel to direction 104 that is parallel (or substantially parallel) to support frame 105 and to wheels support surface 110. Actuator 120 or an additional dedicated actuator of test rig 100 may, for example, incline (e.g. repeatedly incline) wheel support surface 110 about an axis being parallel to direction 103 that is perpendicular (or substantially perpendicular) to support frame 105 and parallel (or substantially parallel) to wheels support surface 110. For example, test rig 100 may include three actuators each to move wheel support surface 110 in one of directions 102, 103, 104 and/or two actuators each to incline wheel support surface 110 about an axis being parallel to one of directions 103, 104. Any other suitable examples and/or configurations of the actuator(s) are also possible. Test rig 100 may include one or more actuators to repeatedly move and/or incline support frame 105 with respect to reference frame 106 and with respect to wheel support surface 110 in one or more directions (e.g. as described below with respect to FIGS. 2A-2B).

The relative position and/or orientation (e.g. angle) between support frame 105 and wheel support surface 110 may be adjustable, e.g. prior to and/or during operation of test rig 100. For example, the relative position and/or orientation (e.g. angle) of support frame 105 and wheel support surface 110 may be adjusted with respect to axis 103 (being perpendicular (or substantially perpendicular) to support frame 105 and parallel (or substantially parallel) to wheels support surface 110) and/or with respect to axis 104 (being parallel (or substantially parallel) to support frame 105 and to wheels support surface 110). For example, reference frame 106 and/or wheel support surface 110 and/or actuator 120 may be rotated and/or displaced relative to surface 80 (e.g. the ground) and/or with respect to each other to adjust the relative position and/or orientation between support frame 105 and wheel support surface 110.

Test rig 100 may include sensors 130. Support frame 105, reference frame 106, wheel support surface 110 and/or actuator 120 may each include one or more of sensors 130. Sensors 130 may, for example, include cameras, accelerometers, distance sensors and/or any other suitable sensors that may measure parameters related to operation of test rig 100 and/or parameters related to operation of various assemblies or subsystems of dual-axle vehicle corner system 90.

Reference is now made to FIG. 1C, which is a schematic illustration of test rig 100 including two wheel support surfaces 112, 114, and of dual-axle vehicle corner system 90 coupled to test rig 100, according to some embodiments of the invention.

Test rig 100 may include a first wheel support surface 112 and a second wheel support surface 114 to support first wheel 91 and second wheel 92 of dual-axle vehicle corner system 90. respectively. Test rig 100 may include a first actuator 122 and a second actuator 124 to repeatedly move first wheel support surface 112 and second wheel surface 114, respectively, in direction 102 that is perpendicular (or substantially perpendicular) to first and second wheel support surfaces 112, 114, respectively. Each of first and second wheel support surfaces 112. 114 may be moved and/or rotated in directions other than direction 102, e.g. as described above with respect to FIGS. 1A and 1B. Each of first actuator 122 and second actuator 124 may include a linear actuator, a vibrational actuator, a circular eccentric cam or any other suitable actuator. First actuator 122 and second actuator 124 may, for example, move first wheel support surface 112 and second wheel support surface 114, respectively, in the same manner. In another example, first actuator 122 and second actuator 124 may move first wheel support surface 112 and second wheel support surface 114, respectively, at different rates, at different amplitudes and/or at different phases with respect to each other. First wheel support surface 112, second wheel support surface 114, first actuator 122 and/or second actuator 124 may each include one or more of sensors 130.

Test rig 100 may change the distance between first wheel support surface 112 and second wheel support surface 114 (e.g., using actuators 122, 124 and/or any other suitable actuators) to change the distance between first wheel 91 and second wheel 92 of dual-axle vehicle corner system 90. The distance between first wheel 91 and second wheel 92 of dual-axle vehicle corner system 90 may be changed by suspension assembly 94 of dual-axle vehicle corner system 90 (e.g., using dedicated hydraulic subsystems and/or any other suitable devices).

Steering assembly 98 (e.g., as shown in FIGS. 5A-5D; not shown in FIGS. 1A-1C for simplicity) of dual-axle vehicle corner system 90 may cause and/or may be controlled e.g. by a computing device 140 to cause first wheel 91 and/or second wheel 92 to steer about their respective steering axes. Steering of first wheel 91 and/or second wheel 92 to steer about their respective steering axes may, for example, allow testing suspension assembly 94 under steering conditions.

Test rig 100 may be connected to or may include computing device 140 (e.g. as shown in FIGS. 1A and 1C). Computing device 140 may control actuator 120 (e.g. in the example of FIGS. 1A and 1B) and actuators 122, 124 (e.g. in the example of FIG. 1C) to repeatedly move wheel support surface 110 and wheel support surfaces 112, 114, respectively, according to a predefined protocol.

Based on signals from sensors 130 of test rig 100 and/or based on signals from sensors 95 of dual-axle vehicle corner system 90, computing device 140 may determine parameters related to operation dual-axle vehicle corner system 90. The parameters related to operation of dual-axle vehicle corner system 90 may, for example, include motion, travel distance, height of vehicle corner system 90 (e.g. sub-frame) of a ground (e.g. measuring of a kneeling function), and/or acceleration of wheels 91, 92, sub-frame 93 and/or components of suspension assembly 94, damping rate of components of suspension assembly 94, height and/or change of height of sub-frame 93 or support frame 105 above ground, or any other suitable parameters.

Based on signals from sensors 130 of test rig 100 and/or based on signals from sensors 95 of dual-axle vehicle corner system 90, computing device 140 may determine whether or not various assemblies or subsystems of dual-axle vehicle corner system 90 (e.g. wheel hubs and/or tires of wheels 91, 92; connectors of sub-frame 93; suspension arms, shock absorbers, dampers, kneeling and/or lifting functionalities of suspension assembly 94 or any other suitable assemblies or subsystems) are tuned and/or operate according to predefined specifications. For example, computing device 140 may determine whether or not suspension parameters (e.g. damping rate or any other suitable suspension parameters) of suspension assembly 94 and/or motion parameters (e.g. travel distance, kneeling, acceleration or any other suitable motion parameters) of wheels 91, 93 and/or sub-frame 93 in response to a given actuation caused by actuator 120 and actuators 122. 124 are in accordance with the predefined specifications of dual-axle vehicle corner system 90. In another example, computing device 140 may determine whether or not kneeling and/or lifting functionality of suspension assembly 94 is in accordance with the predefined specifications for a given load of support frame 105 (wherein the load may be defined by weights 107 coupled to support frame 105). Any other suitable examples of compliance with the predefined specification are also possible. Computing device 140 may issue a notification indicating whether or not dual-axle vehicle corner system 90 operates in accordance with the predefined specifications. The notification may, for example, indicate which of assemblies or subsystems (if any) of dual-axle vehicle corner system 90 does not operate in accordance with the predefined specification.

Based on signals from sensors 130 of test rig 100 and/or based on signals from sensors 95 of dual-axle vehicle corner system 90, computing device 140 may determine predictive information related to operation, possible failures and/or future maintenance procedures for dual-axle vehicle corner system 90.

Based on signals from sensors 130 of test rig 100 and/or based on signals from sensors 95 of dual-axle vehicle corner system 90, computing device 140 may determine whether or not sensors 95 of dual-axle vehicle corner system 90 are calibrated. Computing device 140 may issue a notification indicating whether or not sensors 95 of dual-axle vehicle corner system 90 are calibrated. If it is determined that sensors 95 of dual-axle vehicle corner system 90 are not calibrated, computing device 140 may calibrate sensors 95 of dual-axle vehicle corner system 90 based on signals from sensors 130 of test rig 100.

Computing device 140 may connect to, e.g. an interface 99 of dual-axle vehicle corner system 90 and read structural and functional parameters of dual-axle vehicle corner system 90. Based on the parameters, computing device 140 may control components of test rig 100 to, for example, adjust the distance between support frame 105 and wheel support 110 (e.g. in the example of FIGS. 1A and 1B), adjust the distance between wheel supports 112. 114 (e.g. in the example of FIGS. 1C), adjust the weight of support frame 105 by adding or removing weights 107 and/or adjust any other suitable parameters of test rig 100. Test rig 100 may, for example, include dedicated actuators to adjust parameters of test rig 100 based on the parameters of dual-axle vehicle corner system 90. Computing device 140 may, for example, define the testing protocol based on the parameters and/or utilization history of dual-axle vehicle corner system 90.

Reference is now made to FIGS. 2A and 2B, which are schematic illustrations of a test rig 200 including one or more actuators 220 to repeatedly move a support frame 205 of test rig 200. and of a dual-axle vehicle corner system 90 coupled to test rig 200, according to some embodiments of the invention.

Test rig 200 may include a support frame 205 (e.g. such as support frame 105 described above with respect to FIGS. 1A, 1B and 1C) that may be slidably coupled to a reference frame 206 (e.g. such as frame 106 described above with respect to FIGS. 1A, 1B and 1C). Test rig 200 may include a wheel support surface 210 to support wheels 91, 92 of dual-axle vehicle corner system 90. Wheel support surface 210 may be, for example, stationary with respect to surface 80 (e.g. the ground). Wheel support surface 210 may be perpendicular (or substantially perpendicular) to support frame 205. While single wheel support surface 210 is shown, test rig 200 may include two wheel support surfaces cach to support one of first and second wheels 91, 92 of dual-axle vehicle corner system 90 (e.g. as described above with respect to FIG. 1C).

Test rig 200 may include one or more actuators 220 to repeatedly move support frame 205 of test rig 200 with respect to reference frame 206 and with respect to wheel support surface 210 in one or more directions. Repeated motion of support frame 205 by actuator(s) 220 with respect to reference frame 206 and wheel support surface 210 may, for example, actuate suspension assembly 94 of dual-axle vehicle corner system 90. Actuator(s) 220 may, for example, include linear actuators, vibrational actuators, circular eccentric cams or any other suitable actuators.

Actuator(s) 220 may repeatedly move support frame 205 in a direction 202 that is perpendicular (or substantially perpendicular) to wheel support surface 210. Actuator(s) 220 may repeatedly move support frame 205 in a direction 203 that is that is perpendicular (or substantially perpendicular) to support frame 205 and parallel (or substantially parallel) to wheels support surface 210. Actuator(s) 220 may repeatedly move support frame 205 in a direction 204 that is parallel (or substantially parallel) to support frame 205 and to wheels support surface 210. Actuator(s) 220 may incline (e.g. repeatedly incline) support frame 205 about an axis being parallel to direction 203 that is that is perpendicular (or substantially perpendicular) to support frame 205 and parallel (or substantially parallel) to wheels support surface 210. Actuator(s) 220 may incline (e.g. repeatedly incline) support frame 205 about an axis being parallel to direction 204 that is parallel (or substantially parallel) to support frame 205 and to wheels support surface 210. For example, test rig 200 may include three actuators each to move support frame 205 in one of directions 202, 203, 204 and two actuators each to incline support frame 205 about the axis being parallel to one of directions 203, 204. Any other suitable examples and/or configurations of actuator(s) 220 are also possible.

Test rig 200 may include a plurality of weights 207 that may be coupled to support frame 205 (e.g. such as weights 107 described above with respect to FIGS. 1A, 1B and 1C). Test rig 200 may include sensors 230 (e.g. such as sensors 230 described above with respect to FIGS. 1A, 1B and 1C), wherein support frame 205, reference frame 206, wheel support surface 210 and/or actuator(s) 220 may each include one or more of sensors 230.

Steering assembly 98 (c.g., as shown in FIGS. 5A-5D; not shown in FIGS. 2A-2B for simplicity) of dual-axle vehicle corner system 90 may cause or may be controlled e.g. by a computing device 240 to cause first wheel 91 and/or second wheel 92 to steer about their respective steering axes. Steering of first wheel 91 and/or second wheel 92 to steer about their respective steering axes may, for example, allow testing suspension assembly 94 under steering conditions.

Test rig 200 may be connected to or may include computing device 240 (e.g. such as computing device 140 described above with respect to FIGS. 1A, 1B and 1C). Computing device 240 may control actuator(s) 220 to repeatedly move support frame 205 in accordance with a predefined protocol.

Based on signals from sensors 230 of test rig 200 and/or based on signals from sensors 95 of dual-axle vehicle corner system 90, computing device 240 may determine parameters related to operation dual-axle vehicle corner system 90 (e.g. as described above with respect to FIGS. 1A, 1B and 1C). Based on signals from sensors 230 of test rig 200 and/or based on signals from sensors 95 of dual-axle vehicle corner system 90, computing device 240 may determine whether or not various assemblies or subsystems of dual-axle vehicle corner system 90 are tuned and/or operate according to predefined specifications (e.g. as described above with respect to FIGS. 1A, 1B and 1C). Based on signals from sensors 230 of test rig 200 and/or based on signals from sensors 95 of dual-axle vehicle corner system 90, computing device 240 may determine predictive information related to operation, possible failures and/or future maintenance procedures for dual-axle vehicle corner system 90 (e.g. as described above with respect to FIGS. 1A, 1B and 1C). Based on signals from sensors 230 of test rig 200 and/or based on signals from sensors 95 of dual-axle vehicle corner system 90, computing device 240 may determine whether or not sensors 95 of dual-axle vehicle corner system 90 are calibrated. If it is determined that sensors 95 of dual-axle vehicle corner system 90 are not calibrated, computing device 240 may calibrate sensors 95 of dual-axle vehicle corner system 90 based on signals from sensors 230 of test rig 200 (e.g. as described above with respect to FIGS. 1A, 1B and 1C). Computing device 240 may issue notifications, e.g. as described above with respect to FIGS. 1A, 1B and 1C. Computing device 240 may connect to interface 99 of dual-axle vehicle corner system 90 and read structural and functional parameters of dual-axle vehicle corner system 90. Based on the parameters and/or utilization history of dual-axle vehicle corner system 90, computing device 240 may adjust parameters of test rig 200 (e.g. such as distances, weights, or any other suitable parameters) and/or define the testing protocol (e.g. as described above with respect to FIGS. 1A, 1B and 1C).

Reference is now made to FIGS. 3A and 3B, which are schematic illustrations of a test rig 300 including rollers 310, 312 to rotatably support wheels 91, 91 of dual-axle vehicle corner system 90, and of dual-axle vehicle corner system 90 coupled to test rig 300, according to some embodiments of the invention.

Test rig 300 may be used to, for example, test dual-axle vehicle corner system 90 including a powertrain assembly 96 having a powertrain motor 96a to drive and rotate wheels 91, 92 of dual-axle vehicle corner system 90 (e.g. as described herein below).

Test rig 300 may include a support frame 305 (e.g. such as support frame 105 described above with respect to FIGS. 1A, 1B and 1C). Support frame 305 may be slidably coupled to a reference frame 306 (e.g. such as frame 106 described above with respect to FIGS. 1A, 1B and 1C). Test rig 300 may include a plurality of weights 307 that may be coupled to support frame 305 (e.g. such as weights 107 described above with respect to FIGS. 1A, 1B and 1C). Test rig 300 may include at least one rotatable member to support wheels 91, 92 of dual-axle vehicle corner system 90 while wheels 91, 92 are spinning (e.g. rotating about their respective wheel rotation axes). In the example of FIGS. 3A and 3B, test rig 300 includes a first roller 310 to support first wheel 91 and a second roller 312 to support second wheel 92 of dual-axle vehicle corner system 90 while wheels 91, 92 are spinning. First roller 310 and second roller 312 may be supported by a wheel support surface 320 (e.g. such as wheel support surface 110 described above with respect to FIGS. 1A, 1B and 1C). In some embodiments, test rig 300 includes a first subset of rollers to support first wheel 91 and a second subset of rollers to support second wheel 92 of dual-axle vehicle corner system 90 (e.g. as described below with respect to FIG. 6). In some embodiments, test rig 300 includes a single subset of rollers to support both first wheel and second wheel 92 of dual-axle vehicle corner system 90. The at least one rotatable member of test rig 300 may include components other than rollers to support wheels 91, 92 of dual-axle vehicle corner system 90 while wheels 91, 92 are spinning. For example, the at least one rotatable member may include a rotatable belt mounted on two pulleys to support wheels 91, 92 of dual-axle vehicle corner system 90 while wheels 91, 92 are spinning. Other configurations of rotatable member(s) to rotatably support wheels 91, 92 of dual-axle vehicle corner system 90 are also possible.

Dual-axle vehicle corner system 90 may include powertrain assembly 96 having powertrain motor 96a to drive and spin first wheel 91 and second wheel 92 of dual-axle vehicle corner system 90. Sensors 95 of dual-axle vehicle corner system 90 may further include torque sensors, rotational sensors, power sensors or any other suitable sensors capable of measuring parameters related to operation of powertrain assembly 96 (e.g. powertrain motor 96a and/or other suitable components of powertrain assembly 96). Powertrain assembly 96 may include one or more of sensors 95. In operation on test rig 300, powertrain motor 96a of powertrain assembly 96 may drive and spin and/or may be controlled e.g. by a computing device 350 to drive and spin wheels 91, 92 of dual-axle vehicle corner system 90 while rollers 310, 312 may support wheels 91, 92 while wheels 91, 92 are spinning.

Test rig 300 may include sensors 330. Sensors 330 may be similar to sensors 130 described above with respect to FIGS. 1A, 1B and 1C and may further include torque sensors, rotational sensors, power sensors or any other suitable sensors capable of measuring parameters related to operation of powertrain assembly 96 (e.g. powertrain motor 96a and/or other suitable components of powertrain assembly 96).

Test rig 300 may include a motor 340 to rotate first roller 310 and second roller 312. For example, motor 340 may rotate rollers 310, 312 in a direction that is opposite to a direction of rotation of wheels 91, 92 caused by powertrain assembly 96 to, for example, generate a desired measure of resistance to operation of powertrain motor 96a of powertrain assembly 96 (e.g. to test operation of powertrain motor 96a and/or other suitable components of powertrain assembly 96 and/or other assemblies or subsystems of dual-axle vehicle corner system 90 under resistance). Motor 340 may include one or more of sensors 330 (e.g. power/current sensor, torque sensor, etc.). Test rig 300 may, for example, include a transmission 341 (e.g. including one or more shafts, one or more belts or any other suitable transmission components) to transmit rotations of motor 340 to rollers 310, 312. While single motor 340 is shown in FIGS. 3A and 3B, test rig 300 may include more than one motor. For example, test rig 300 may include two motors cach to rotate one of rollers 310, 312.

Motor 340 of test rig 300 may, for example, rotate rollers 310, 312 to spin wheels 91, 92 of dual-axle vehicle corner system 90 to actuate regeneration functionality of powertrain motor 96a of dual-axle vehicle corner system 90. For example, spinning of wheels 91, 92 of dual-axle vehicle corner system 90 by operation of motor 340 of test rig 300 emulate a situation in which the vehicle (e.g. electrical vehicle) is driving, e.g. downhill and not due to operation of powertrain motor 96a of dual-axle vehicle corner system 90, the situation that may actuate EV regeneration and brake regeneration functionality of powertrain motor 96a (e.g. caused by electro-magnetic resistance of powertrain motor 96a).

Steering assembly 98 (e.g., as shown in FIGS. 5A-5D; not shown in FIGS. 3A-3B for simplicity) of dual-axle vehicle corner system 90 may cause or may be controlled e.g. by computing device 350 to cause first wheel 91 and/or second wheel 92 to steer about their respective steering axes. Steering of first wheel 91 and/or second wheel 92 to steer about their respective steering axes may, for example, allow testing powertrain assembly 96 under steering conditions.

Dual-axle vehicle corner system may include a first braking actuator 91a to control the braking of first wheel 91 and a second braking actuator 92a to control the braking of second wheel 92 of dual-axle vehicle corner system. In operation on test rig 300, first barking actuator 91a and/or second braking actuator 92a may be controlled (e.g., actuated) by e.g. computing device 350, for example to resist the spinning of first wheel 91 and/or the spinning of second wheel 92 caused by test rig 300 and/or by powertrain assembly 96. Actuation of first braking actuator 91a and/or of second braking actuator 92a while first wheel 91 and/or second wheel 92 are caused to spin by test rig 300 and/or by powertrain assembly 96 may allow testing first braking actuator 91a and/or of second braking actuator 92a of the dual-axle vehicle corner system 90. First barking actuator 91a and/or second braking actuator 92a may each include a brake drum, a brake caliper and/or any other suitable component.

Test rig 300 may be connected to or may include computing device 350 (e.g. such as computing device 140 described above with respect to FIGS. 1A, 1B and 1C). Computing device 350 may control motor 340 to rotate rotatable member 310, 312 according to a predefined protocol.

Based on signals from sensors 330 of test rig 300 and/or based on signals from sensors 95 of dual-axle vehicle corner system 90, computing device 350 may determine parameters related to operation dual-axle vehicle corner system 90. The parameters related to operation of dual-axle vehicle corner system 90 may, for example, include motion and/or vibration of wheels 91, 92, sub-frame 93 and/or components of suspension assembly 94; rotational speed of wheels 91, 92; acceleration and/or deceleration of wheels 91, 92 associated with, e.g. braking of wheels 91, 92; power consumption of motor(s) of powertrain assembly 96; balancing of wheels 91, 92; traction of wheels 91, 92 with rotatable members 310, 312; or any other suitable parameters.

Based on signals from sensors 330 of test rig 300 and/or based on signals from sensors 95 of dual-axle vehicle corner system 90, computing device 350 may determine whether or not various assemblies or subsystems of dual-axle vehicle corner system 90 (e.g. wheel hubs and/or tires of wheels 91, 92; connectors of sub-frame 93; suspension arms, shock absorbers and/or dampers suspension assembly 94 or any other suitable assemblies or subsystems) are tuned and/or operate according to predefined specifications. For example, computing device 350 may determine whether or not motion and/or vibration of wheels 91, 92, sub-frame 93 and/or components of suspension assembly 94 caused by rotation and/or braking of wheels 91, 92 are in accordance with the predefined specifications. In another example, computing device 350 may determine whether or not power consumption of powertrain motor 96a of powertrain assembly 96 is in accordance with the predefined specifications of dual-axle vehicle corner system 90. In another example, computing device 350 may determine whether or not regeneration functionality of powertrain motor 96a of powertrain assembly 96 is in accordance with the predefined specifications of dual-axle vehicle corner system 90. In another example, computing device 350 may determine whether or not balancing of wheels 91, 92 with respect to each other is in accordance with the predefined specifications. In another example, computing device 350 may determine whether or not traction of wheels 91, 92 with rotatable members 310, 312 is in accordance with the predefined specifications. Any other suitable examples of compliance with the predefined specification are also possible.

Based on signals from sensors 330 of test rig 300 and/or based on signals from sensors 95 of dual-axle vehicle corner system 90, computing device 350 may determine predictive information related to operation, possible failures and/or future maintenance procedures for dual-axle vehicle corner system 90 (e.g. as described above with respect to FIGS. 1A, 1B and 1C).

Based on signals from sensors 330 of test rig 300 and/or based on signals from sensors 95 of dual-axle vehicle corner system 90, computing device 350 may determine whether or not sensors 95 of dual-axle vehicle corner system 90 are calibrated. If it is determined that sensors 95 of dual-axle vehicle corner system 90 are not calibrated, computing device 350 may calibrate sensors 95 of dual-axle vehicle corner system 90 based on signals from sensors 330 of test rig 300 (e.g. as described above with respect to FIGS. 1A, 1B and 1C).

Computing device 350 may issue notifications, e.g. as described above with respect to FIGS. 1A, 1B and 1C. Computing device 350 may connect to interface 99 of dual-axle vehicle corner system 90 and read structural and functional parameters of dual-axle vehicle corner system 90. Based on the parameters and/or utilization history of dual-axle vehicle corner system 90, computing device 350 may adjust parameters of test rig 300 (e.g. such as distances, weights, or any other suitable parameters) and/or define the testing protocol (e.g. as described above with respect to FIGS. 1A, 1B and 1C).

Reference is now made to FIGS. 4A and 4B, which are schematic illustrations of a test rig 400 including rollers 410, 412 to rotatably support and cause wheels 91, 91 of dual-axle vehicle corner system 90 to spin, and of dual-axle vehicle corner system 90 coupled to test rig 400, according to some embodiments of the invention.

Test rig 400 may be used to, for example, test dual-axle vehicle corner system 90 including a drivetrain assembly 97. Drivetrain assembly 97 may be similar to powertrain assembly 96, but have no motor that causes wheels 91, 92 to spin about their respective wheel rotation axes.

Test rig 400 may include a support frame 405 (e.g. such as support frame 305 described above with respect to FIGS. 3A and 3B). Support frame 405 may be slidably coupled to a reference frame 406 (e.g. such as frame 306 described above with respect to FIGS. 3A and 3B). Test rig 400 may include a plurality of weights 407 that may be coupled to support frame 405 (e.g. such as weights 107 described above with respect to FIGS. 1A, 1B and 1C).

Test rig 400 may include at least one rotatable member to support and cause wheels 91, 92 of dual-axle vehicle corner system 90 while wheels 91, 92 to rotate. For example, test rig 400 may include a first roller 410 to support and cause first wheel 91 to spin (c.g. rotate about its respective wheel rotation axis) and a second roller 412 to support and cause second wheel 92 to spin (e.g. such as first and second rollers 310, 312, respectively, described above with respect to FIGS. 3A and 3B). First and second rollers 410, 412 may be supported by a wheel support surface 420 (e.g. such as wheel support surface 320 described above with respect to FIGS. 3A and 3B). Other possible configurations of rotatable member(s) described above with respect to FIGS. 3A and 3B are applicable to the example of FIGS. 4A and 4B as well. Test rig 400 may include sensors 430 (e.g. such as sensors 330 described above with respect to FIGS. 3A and 3B).

Test rig 400 may include a motor 440 to rotate first roller 410 and second roller 412 and to cause first wheel 91 and second wheel 92 to spin. Test rig 400 may, for example, include a transmission 441 (e.g. including one or more shafts, one or more belts or any other suitable transmission component known in the art) to transmit rotations of motor 430 to rollers 410, 412. While single motor 440 is shown in FIGS. 4A and 4B, test rig 400 may include more than one motor. For example, test rig 300 may include two motors each to rotate one of rollers 410, 412 (e.g. as described above with respect to FIGS. 3A and 3B).

Steering assembly 98 (e.g., as shown in FIGS. 5A-5D; not shown in FIGS. 4A-4B for simplicity) of dual-axle vehicle corner system 90 may cause or may be controlled e.g. by a computing device 450 to cause first wheel 91 and/or second wheel 92 to steer about their respective steering axes. Steering of first wheel 91 and/or second wheel 92 to steer about their respective steering axes may, for example, allow testing drivetrain assembly 97 under steering conditions.

In operation on test rig 400, first barking actuator 91a and/or second braking actuator 92a may be controlled (e.g., actuated) by e.g. computing device 450, for example to resist the spinning of first wheel 91 and/or the spinning of second wheel 92 caused by test rig 400. Actuation of first braking actuator 91a and/or of second braking actuator 92a while first wheel 91 and/or second wheel 92 are caused to spin by test rig 400 may allow testing first braking actuator 91a and/or of second braking actuator 92a of the dual-axle vehicle corner system 90.

Test rig 400 may be connected to or may include computing device 450 (e.g. such as computing device 350 described above with respect to FIGS. 3A and 3B). Computing device 450 may control motor 440 to rotate rotatable members 410, 412 according to a predefined protocol.

Based on signals from sensors 430 of test rig 400 and/or based on signals from sensors 95 of dual-axle vehicle corner system 90, computing device 450 may determine parameters related to operation dual-axle vehicle corner system 90. The parameters related to operation of dual-axle vehicle corner system 90 may, for example, include motion and/or vibration of wheels 91, 92, sub-frame 93 and/or components of suspension assembly 94; rotational speed of wheels 91, 92; accelerations and/or deceleration of wheels 91, 92 associated with, e.g. braking of wheels 91, 92; balancing of wheels 91, 92; traction of wheels 91, 92 with rotatable members 410, 412; or any other suitable parameters.

Based on signals from sensors 430 of test rig 400 and/or based on signals from sensors 95 of dual-axle vehicle corner system 90, computing device 450 may determine whether or not various assemblies or subsystems of dual-axle vehicle corner system 90 (e.g. wheel hubs and/or tires of wheels 91, 92; connectors of sub-frame 93; suspension arms, shock absorbers and/or dampers suspension assembly 94 or any other suitable assemblies or subsystems) are tuned and/or operate according to predefined specifications. For example, computing device 450 may determine whether or not motion and/or vibration of wheels 91, 92, sub-frame and/or components of suspension assembly 94 caused by rotation and/or braking of wheels 91, 92 are in accordance with the predefined specifications. In another example, computing device 450 may determine whether or not power consumption of motor(s) of drivetrain assembly 97 is in accordance with the predefined specifications of dual-axle vehicle corner system 90. In another example, computing device 450 may determine whether or not balancing of wheels 91, 92 is in accordance with the predefined specifications. In another example, computing device 450 may determine whether or not traction of wheels 91, 92 with rotatable members 410, 412 is in accordance with the predefined specifications. Any other suitable examples of compliance with the predefined specification are also possible.

Based on signals from sensors 430 of test rig 400 and/or based on signals from sensors 95 of dual-axle vehicle corner system 90, computing device 450 may determine predictive information related to operation, possible failures and/or future maintenance procedures for dual-axle vehicle corner system 90 (e.g. as described above with respect to FIGS. 1A, 1B and 1C).

Based on signals from sensors 430 of test rig 400 and/or based on signals from sensors 95 of dual-axle vehicle corner system 90, computing device 450 may determine whether or not sensors 95 of dual-axle vehicle corner system 90 are calibrated. If it is determined that sensors 95 of dual-axle vehicle corner system 90 are not calibrated, computing device 450 may calibrate sensors 95 of dual-axle vehicle corner system 90 based on signals from sensors 430 of test rig 300 (e.g. as described above with respect to FIGS. 1A, 1B and 1C).

Computing device 450 may issue notifications, e.g. as described above with respect to FIGS. 1A, 1B and 1C. Computing device 450 may connect to interface 99 of dual-axle vehicle corner system 90 and read structural and functional parameters of dual-axle vehicle corner system 90. Based on the parameters and/or utilization history of dual-axle vehicle corner system 90, computing device 450 may adjust parameters of test rig 400 (e.g. such as distances, weights, or any other suitable parameters) and/or define the testing protocol (e.g. as described above with respect to FIGS. 1A, 1B and 1C).

Reference is now made to FIGS. 5A and 5B, which are schematic illustrations of a test rig 500 including a rotatable wheel support surface 510, and of dual-axle vehicle corner system 90 coupled to test rig 500, according to some embodiments of the invention.

Test rig 500 may be used to, for example, test dual-axle vehicle corner system 90 including a steering assembly 98 to steer wheels 91, 92 of dual-axle vehicle corner system 90 (e.g. as described herein below).

Test rig 500 may include a support frame 505 (e.g. such as support frame 105 described above with respect to FIGS. 1A, 1B and 1C). Support frame 505 may be slidably coupled to a reference frame 506 (e.g. such as frame 106 described above with respect to FIGS. 1A, 1B and 1C). Test rig 500 may include a plurality of weights 507 that may be coupled to support frame 505 (e.g. such as weights 107 described above with respect to FIGS. 1A, 1B and 1C).

Test rig 500 may include a wheel support surface 510. Wheel support surface 510 may be perpendicular (or substantially perpendicular) to support frame 505. Wheel support surface 510 may support first wheel 91 and second wheel 92 of dual-axle vehicle corner system 90. Wheel support surface 510 may be rotatable (e.g. steerable) about an axis 511 that is perpendicular (or substantially perpendicular) to wheel support surface 510. Test rig 500 may include a motor 520 to rotate wheel support surface 510 about axis 511. Test rig 500 may include a transmission 521 (e.g. including one or more shafts, one or more belts or any other suitable transmission component known in the art) to transmit rotations of motor 521 to wheel support surface 510.

Dual-axle vehicle corner module 90 may include steering assembly 98. Steering assembly 98 may steer wheels 91, 92 of dual-axle vehicle corner system 90. Sensors 95 of dual-axle vehicle corner system 90 may further include torque sensors, steering angle sensors, power sensors or any other suitable sensors capable of measuring parameters related to operation of steering assembly 98. Steering assembly 98 may include one or more of sensors 95. Rotation of wheel support surface 510 about axis 511 by motor 520 may, for example, actuate steering assembly 98 of dual-axle vehicle corner system 90. For example, steering assembly 98 may resist to rotation of wheel support surface 510 about axis 511 to, for example, test toe control functionality of steering assembly 98 and/or to test other assemblies or subsystems of dual-axle vehicle corner system 90.

Test rig 500 may include sensors 530. Sensors 530 may be similar to sensors 130 described above with respect to FIGS. 1A, 1B and 1C and may further include torque sensors, steering angle sensors, power sensors or any other suitable sensors capable of measuring parameters related to operation of steering assembly 98. Motor 520 may include one or more of sensors 530.

Reference is now made to FIGS. 5C and 5D, which is a schematic illustration of test rig 500 including two rotatable wheel support surfaces 512, 514, and of dual-axle vehicle corner system 90 coupled to test rig 500, according to some embodiments of the invention.

Test rig 500 may include a first wheel support surface 512 and a second wheel support surface 514 to support first wheel 91 and second wheel 92 of dual-axle vehicle corner system 90, respectively. First wheel support surface 512 may be rotatable about an axis 513 that is perpendicular (or substantially perpendicular) to first wheel support surface 512. Second wheel support surface 514 may be rotatable about an axis 515 that is perpendicular (or substantially perpendicular) to second wheel support surface 514. Each of first and second wheel support surfaces 512, 514 may include one or more of sensors 130. In the example of FIG. 5C, test rig 500 includes a motor 522 to rotate both first and second wheel support surfaces 512, 514, e.g. via first and second transmissions 523, 524. In the example of FIG. 5D, test rig 500 includes a first motor 525 to rotate first wheel support surface 512 optionally via first transmission 523 and a second motor 526 to rotate second wheel support surface 514 optionally via second transmission 524. First and second wheel support surfaces 512, 514 may be, for example, rotatable in the same manner. In another example, first and second wheel support surfaces 512, 514 may be rotatable to different steering angles and/or at different rates with respect to each other (e.g. by controlling motor 522, transmissions 523, 524 and/or motors 525, 526). Each of motors 525, 526 may include one or more of sensors 530.

Test rig 500 may be connected to or may include a computing device 540 (e.g. such as computing device 140 described above with respect to FIGS. 1A, 1B and 1C). Computing device 540 may control motors 520, 522 (e.g. in the examples of FIGS. 5A-5B and 5C, respectively) and motors 525, 526 (e.g. in the example of FIG. 5D) to rotate rotatable member 510 and rotatable members 512, 514, respectively, according to a predefined protocol.

Based on signals from sensors 530 of test rig 500 and/or based on signals from sensors 95 of dual-axle vehicle corner system 90, computing device 540 may determine parameters related to operation dual-axle vehicle corner system 90. The parameters related to operation of dual-axle vehicle corner system 90 may, for example, include motion and/or vibration of wheels 91, 92, sub-frame 93 and/or components of suspension assembly 94; power consumption of motor(s) of steering assembly 98; toe control parameters of steering assembly 98; alignment of wheels 91, 92; or any other suitable parameters.

Based on signals from sensors 530 of test rig 500 and/or based on signals from sensors 95 of dual-axle vehicle corner system 90, computing device 540 may determine whether or not various assemblies or subsystems of dual-axle vehicle corner system 90 (e.g. wheel hubs and/or tires of wheels 91, 92; connectors of sub-frame 93; steering actuators of steering assembly 98; toe control of steering assembly 98; or any other suitable assemblies or subsystems) are tuned and/or operate according to predefined specifications.

Based on signals from sensors 530 of test rig 500 and/or based on signals from sensors 95 of dual-axle vehicle corner system 90, computing device 540 may determine whether or not sensors 95 of dual-axle vehicle corner system 90 are calibrated. If it is determined that sensors 95 of dual-axle vehicle corner system 90 are not calibrated, computing device 540 may calibrate sensors 95 of dual-axle vehicle corner system 90 based on signals from sensors 530 of test rig 500 (e.g. as described above with respect to FIGS. 1A, 1B and 1C).

Based on signals from sensors 530 of test rig 500 and/or based on signals from sensors 95 of dual-axle vehicle corner system 90, computing device 540 may determine predictive information related to operation, possible failures and/or future maintenance procedures for dual-axle vehicle corner system 90 (e.g. as described above with respect to FIGS. 1A, 1B and 1C).

Computing device 540 may issue notifications, e.g. as described above with respect to FIGS. 1A, 1B and 1C. Computing device 540 may connect to interface 99 of dual-axle vehicle corner system 90 and read structural and functional parameters of dual-axle vehicle corner system 90. Based on the parameters and/or utilization history of dual-axle vehicle corner system 90, computing device 540 may adjust parameters of test rig 500 (e.g. such as distances, weights, or any other suitable parameters) and/or define the testing protocol (e.g. as described above with respect to FIGS. 1A, 1B and 1C).

The illustrations/description above describe embodiments of test rigs for dual-axle vehicle corner systems. Each of these embodiments may include features from other embodiments presented, and embodiments not specifically described may include various features described herein.

For example, test rig 100 including wheel support surface 110 movable in the direction that is perpendicular to wheel support surface 110, e.g. to test, inter alia, suspension capabilities of dual-axle vehicle corner system 90 as described above with respect to FIGS. 1A, 1B and 1C, may also include rotatable members 310, 312 to rotatable support wheels 91, 92 and/or cause wheels 91. 92 to rotate, e.g. to test powertrain and/or drivetrain capabilities of dual-axle vehicle corner system 90 as described above with respect to FIGS. 3A-3B and FIGS. 4A-4B.

In another example, wheel support surface 110 of test rig 100 movable in the direction that is perpendicular to wheel support surface 110, e.g. to test, inter alia, suspension capabilities of dual-axle vehicle corner system 90 as described above with respect to FIGS. 1A, 1B and 1C, may be also rotatable about an axis that is perpendicular to wheel support surface 110, e.g. like wheel support surface 510 described above with respect to FIGS. 5A and 5B, to, e.g. test steering capabilities of dual-axle vehicle corner system 90.

In another example, wheel support surface 320 of test rig 300 including rotatable members 310, 312 to, e.g. test powertrain and/or drivetrain capabilities of dual-axle vehicle corner system 90 as described above with respect to FIGS. 3A-3B, 4A-4B, may be also rotatable about an axis that is perpendicular to wheel support surface 110, e.g. like wheel support surface 510 described above with respect to FIGS. 5A and 5B, to, e.g. test steering capabilities of dual-axle vehicle corner system 90.

In another example, test rig 100 including wheel support surface 110 movable in the direction that is perpendicular to wheel support surface 110, e.g. to test, inter alia, suspension capabilities of dual-axle vehicle corner system 90 as described above with respect to FIGS. 1A, 1B and 1C, may also include rotatable members 310, 312 to e.g. to test powertrain capabilities of dual-axle vehicle corner system 90 as described above with respect to FIGS. 3A and 3B, and may further be rotatable about an axis that is perpendicular to wheel support surface 110, e.g. like wheel support surface 510 described above with respect to FIGS. 5A and 5B, to, e.g. test steering capabilities of dual-axle vehicle corner system 90.

Other not specifically described combinations of features from different embodiments of test rigs are also possible.

Reference is now made to FIG. 6, which is a 3D diagram of a test rig 600 and of dual-axle vehicle corner system 90 coupled to test rig 600, according to some embodiments of the invention.

Test rig 600 may include a support frame 605 (e.g. such as support frame 105 described above with respect to FIGS. 1A, 1B and 1C). Support frame 605 may be slidably coupled to a reference frame 606 (e.g. such as frame 106 described above with respect to FIGS. 1A, 1B and 1C). Test rig 600 may include a plurality of weights 607 that may be coupled to support frame 605 (e.g. such as weights 107 described above with respect to FIGS. 1A, 1B and 1C).

Test rig 600 may include a wheel support surface 610 (e.g. such as wheel support surface 110 described above with respect to FIGS. 1A and 1B). Wheel support surface 610 may support wheels 91, 92 of dual-axle vehicle corner system 90. While one wheel support surface 610 is shown, test rig may include two wheel support surfaces each to support one of wheels 91, 92 (e.g. as described above with respect to FIG. 1C).

Test rig 600 may include an actuator 620 to repeatedly move wheel support surface 610 in a direction 602 that is perpendicular (or substantially perpendicular) to wheel support surface 610, e.g. to acuate suspension assembly 94 of dual-axle vehicle corner system (e.g. as described above with respect to FIGS. 1A and 1B). In the example of FIG. 6, actuator 620 includes a circular eccentric cam 621, a motor 622 to rotate circular eccentric cam 621 and a transmission 623 (e.g. including a shaft 623a and a belt 623b and/or any other suitable transmission components) to transfer rotations of motor 622 to circular eccentric cam 621. Other suitable actuators may also be used (e.g. as described above with respect to FIGS. 1A and 1B).

Test rig 600 may include a first set rollers 630 mounted within wheel support surface 610 to rotatably support first wheel 91 and a second set of rollers 632 mounted within wheel support surface 610 to rotatably support second wheel 91 of dual-axle vehicle corner assembly 90 and to allow wheels 91, 92 to rotate, e.g. in response to operation of powertrain assembly 96 of dual-axle vehicle corner system 90. For example, each of first set of rotatable members 630 may be similar to roller 310 of test rig 300 or roller 410 of test rig 400, and each of second set of rollers 632 may be similar to roller 312 of test rig 300 or roller412 of test rig 400 as described hereinabove. Test rig 600 may include other features of test rig 300 and/or of test rig 400, such as actuators, motors, sensors or any other suitable features as described above with respect to FIGS. 3A, 3B and FIGS. 4A. 4B

Test rig 600 may be connected to or may include a computing device (not shown). The computing device may determine parameters related to operation dual-axle vehicle corner system 90, determine whether or not various assemblies or subsystems of dual-axle vehicle corner system 90 are tuned and/or operate according to predefined specifications and/or calibrate sensors 95 of dual-axle vehicle corner system 90 and/or perform any other suitable operations as described above with respect to FIGS. 1A, 1B, 1C, FIGS. 3A, 3B and FIGS. 4A, 4B.

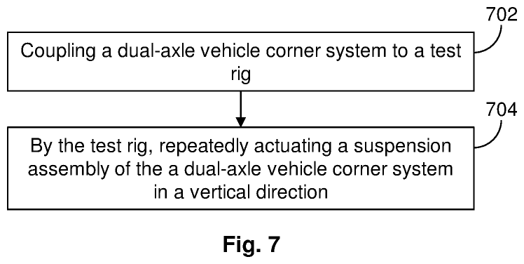

Reference is now made to FIG. 7, which is a flowchart of a method of testing a dual-axle vehicle corner system including a suspension assembly, according to some embodiments of the invention.

The operations described with respect to FIG. 7 may be performed using test rigs 100, 200, 300, 400, 500, 600 described hereinabove and/or any other suitable equipment.

In operation 702, a dual-axle vehicle corner system (e.g., dual-axle vehicle corner system 90 described hereinabove) may be coupled to a test rig (e.g., test rig 100, 200, 300, 400, 500, 600 described hereinabove). For example, a sub-frame (e.g., sub-frame 93 described hereinabove) and/or any other suitable component of the dual-axle vehicle corner system may be coupled (e.g., rigidly or with one or more degrees of freedom) to a support frame (e.g., support frame 105 described hereinabove) of the test rig (e.g., as described hereinabove).

In operation 704, the suspension assembly (e.g., suspension assembly 94 described hereinabove) of the dual-axle vehicle corner system may be repeatedly actuated by the test rig in a vertical direction, wherein the vertical direction may be perpendicular to spinning axes of a first wheel (e.g., first wheel 91 described hereinabove) and a second wheel (e.g., second wheel 92 described hereinabove) coupled the suspension assembly.

The suspension assembly may be actuated by repeatedly causing motion of at least one of the first wheel and the second wheel in the vertical direction with respect to the sub-frame of the dual-axle vehicle corner system (e.g., as described above with respect to FIGS. 1A-1C). For example, the first wheel and/or the second wheel may be moved in the vertical direction by moving at least one wheel support surface of the test rig in the vertical direction (e.g., wheel support surface 110 as described above with respect to FIGS. 1A-1B or first wheel support surface 112 and second wheel support surface 114 as described above with respect to FIG. 1C).

The suspension assembly may be actuated by repeatedly causing motion of the sub-frame of the dual-axle vehicle corner system with respect to at least one of the first wheel and the second wheel in the vertical direction (e.g., as described above with respect to FIGS. 2A-2B). For example, the sub-frame may be moved in the vertical direction by moving the support frame of the test rig in the vertical direction (e.g., as described above with respect to FIGS. 2A-2B).

The suspension assembly may be actuated by repeatedly causing motion of at least one of the first wheel, the second wheel and the sub-frame of the dual-axle vehicle corner system in directions that are transverse to the vertical direction, for by moving the at least one wheel support and/or the support frame of the test rig in directions that are transverse to the vertical direction (e.g., as described above with respect to FIGS. 1A-1C and FIGS. 2A-2B).

The suspension assembly may be actuated by inclining the support frame of the test rig coupled to the sub-frame of the dual-axle vehicle corner system with respect to the at least one wheel support surface of the test rig supporting the first wheel and the second wheel (e.g., as described above with respect to FIGS. 1A-1C and FIGS. 2A-2B). The inclination may be about an axis that is substantially transverse to the spinning axes of the first wheel and the second wheel and/or about an axis that is substantially parallel to the spinning axes of the first wheel and the second wheel (e.g., as described above with respect to FIGS. 1A-1C and FIGS. 2A-2B).

The weight of the dual-axle vehicle corner system may be adjusted by coupling a plurality of weights (e.g., such as weights 107 described above with respect to FIGS. 1A-1C) to the dual-axle vehicle corner system. The coupling of the plurality of weights may be to a component of the test rig to which the dual-axle vehicle corner system is coupled, for example to the support frame of the test rig (e.g., as described above with respect to the FIGS. 1A-1C and FIGS. 2A-2B).

The first wheel and/or the second wheel coupled to the suspension assembly of the dual-axle vehicle corner system may be caused, by the test rig, to spin about their respective spinning axes. For example, the test rig may rotate at least one rotatable member supporting the first wheel and/or the second wheel (e.g., rotatable members 310, 312 described above with respect to FIGS. 3A-3B and/or rotatable members 410, 412 described above with respect to FIGS. 4A-4B) to cause the first wheel and/or the second wheel to spin.

A powertrain assembly (e.g., such as powertrain assembly 96 described here above) of the dual-axle vehicle corner system, may cause and/or may be controlled by the test rig to cause at least one of the first wheel and the second wheel to spin. The operation of the powertrain assembly may be resisted by the test rig by applying a rotational force on at least one of the first wheel and the second wheel in a direction that is opposite to direction of spinning of the first wheel and the second wheel, for example by at least one rotatable member 410, 412 supporting the first wheel and the second wheel (e.g., as described above with respect to FIGS. 4A-4B).

A steering assembly (e.g., steering assembly 98 described hereinabove) of the dual-axle vehicle corner system may be actuated by the test rig by causing the first wheel, the second wheel or both to repeatedly rotate about their respective steering axes that are substantially parallel to the spinning axes of the first wheel and the second wheel (e.g., using rotatable wheel support surface 510 as described above with respect to FIGS. 5A-5B or rotatable wheel support surfaces 512, 514 as described above with respect to FIGS. 5C-5D). The steering assembly of the dual-axle vehicle corner system may cause and/or may be controlled by the test rig to cause at least one of the first wheel and the second wheel to steer about their respective steering axes during actuating of the suspension assembly (e.g., as described above with respect to FIGS. 5A-5D).

Based on signals from at least one of sensors of the dual-axle vehicle corner system or sensors of the test rig, it may be determined by a computing device (e.g., such as computing devices 140, 240, 350, 450, 540 described hereinabove) whether or not subsystems of the dual-axle vehicle corner system are at least one of tuned and operate according to predefined specifications (e.g., as described above with respect to FIGS. 1A-1C, 2A-2B, 3A-3B, 4A-4B and 5A-5D). By the computing device, the sensors of the of the dual-axle vehicle corner system may be calibrated based on signals from the sensors of the test rig (e.g., as described above with respect to FIGS. 1A-1C, 2A-2B, 3A-3B, 4A-4B and 5A-5D).

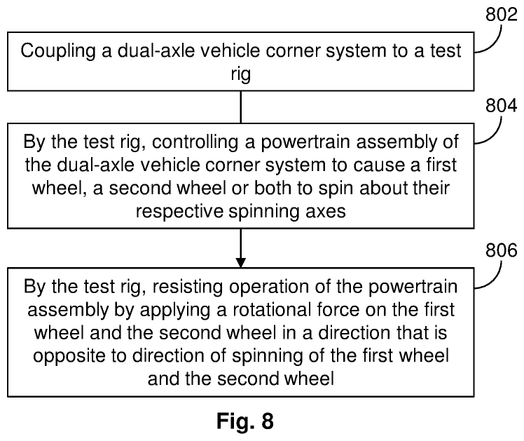

Reference is now made to FIG. 8, which is a flowchart of a method of testing a dual-axle vehicle corner system including a powertrain motor, according to some embodiments of the invention.

The operations described with respect to FIG. 8 may be performed using test rigs 100. 200, 300, 400, 500, 600 described hereinabove and/or any other suitable equipment.

In operation 802, a dual-axle vehicle corner system (e.g., dual-axle vehicle corner system 90 described hereinabove) may be coupled to a test rig (e.g., test rig 100, 200, 300, 400, 500, 600 described hereinabove). For example, a sub-frame (e.g., sub-frame 93 described hereinabove) and/or any other suitable component of the dual-axle vehicle corner system may be coupled (e.g., rigidly or with one or more degrees of freedom) to a support frame (e.g., support frame 105 described hereinabove) of the test rig (e.g., as described hereinabove).

In operation 804, the powertrain assembly (e.g., such as powertrain assembly 96 described here above) may be controlled by the test rig to cause a first wheel and/or a second wheel coupled to a suspension assembly of the axle vehicle corner system to spin about their respective spinning axes (e.g., as described above with respect to FIGS. 3A-3B).

In operation 806, the operation of the powertrain assembly may be resisted by the test rig by applying a rotational force on at least one of the first wheel and the second wheel in a direction that is opposite to direction of spinning of the first wheel and the second wheel (e.g., by the at least one rotatable member 410, 412 supporting the first wheel and the second wheel (e.g., as described above with respect to FIGS. 4A-4B).

The first wheel and/or the second wheel of the dual-axle vehicle corner system may be caused to spin by the test rig to actuate regeneration functionality of the powertrain motor of the powertrain assembly of the dual-axle vehicle corner system (e.g., as described above with respect to FIGS. 3A-3B).

A first braking actuator and/or a second braking actuator of the dual-axle vehicle corner system (e.g., such as barking actuators 91a, 92a described above with respect to FIGS. 3A-3B and 4A-4B) may be controlled by the test rig. For example, the first braking actuator and/or the second braking actuator may be actuated by the test rig, for example to resist the spinning of the first wheel and/or the spinning of the second wheel caused by the test rig and/or by the powertrain assembly of the dual-axle vehicle corner system. Actuation of the first braking actuator and/or of the second braking actuator while the first wheel and/or the second wheel are caused to spin by the test rig and/or by the powertrain assembly may allow testing the first braking actuator and/or the second braking actuator of the dual-axle vehicle corner system.

A suspension assembly (e.g., suspension assembly 94 described hereinabove) of the dual-axle vehicle corner system may be repeatedly actuated by the test rig in a vertical direction, wherein the vertical direction may be perpendicular to spinning axes of the first wheel (e.g., first wheel 91 described hereinabove) and the second wheel (e.g., second wheel 92 described hereinabove) coupled the suspension assembly.

The suspension assembly may be actuated by repeatedly causing motion of at least one of the first wheel and the second wheel in the vertical direction with respect to the sub-frame of the dual-axle vehicle corner system (e.g., as described above with respect to FIGS. 1A-1C). For example, the first wheel and/or the second wheel may be moved in the vertical direction by moving at least one wheel support surface of the test rig in the vertical direction (e.g., wheel support surface 110 as described above with respect to FIGS. 1A-1B or first wheel support surface 112 and second wheel support surface 114 as described above with respect to FIG. 1C).

The suspension assembly may be actuated by repeatedly causing motion of the sub-frame of the dual-axle vehicle corner system with respect to at least one of the first wheel and the second wheel in the vertical direction (e.g., as described above with respect to FIGS. 2A-2B). For example, the sub-frame may be moved in the vertical direction by moving the support frame of the test rig in the vertical direction (e.g., as described above with respect to FIGS. 2A-2B).

The suspension assembly may be actuated by repeatedly causing motion of at least one of the first wheel, the second wheel and the sub-frame of the dual-axle vehicle corner system in directions that are transverse to the vertical direction, for by moving the at least one wheel support and/or the support frame of the test rig in directions that are transverse to the vertical direction (e.g., as described above with respect to FIGS. 1A-1C and FIGS. 2A-2B).

The suspension assembly may be actuated by inclining the support frame of the test rig coupled to the sub-frame of the dual-axle vehicle corner system with respect to the at least one wheel support surface of the test rig supporting the first wheel and the second wheel (e.g., as described above with respect to FIGS. 1A-1C and FIGS. 2A-2B). The inclination may be about an axis that is substantially transverse to the spinning axes of the first wheel and the second wheel and/or about an axis that is substantially parallel to the spinning axes of the first wheel and the second wheel (e.g., as described above with respect to FIGS. 1A-1C and FIGS. 2A-2B).

The weight of the dual-axle vehicle corner system may be adjusted by coupling a plurality of weights (e.g., such as weights 107 described above with respect to FIGS. 1A-1C) to the dual-axle vehicle corner system. The coupling of the plurality of weights may be to a component of the test rig to which the dual-axle vehicle corner system is coupled, for example to the support frame of the test rig (e.g., as described above with respect to the FIGS. 1A-1C and FIGS. 2A-2B).

A steering assembly (e.g., steering assembly 98 described hereinabove) of the dual-axle vehicle corner system by be actuated by the test rig by causing the first wheel, the second wheel or both to repeatedly rotate about their respective steering axes that are substantially parallel to the spinning axes of the first wheel and the second wheel (e.g., using rotatable wheel support surface 510 as described above with respect to FIGS. 5A-5B or rotatable wheel support surfaces 512, 514 as described above with respect to FIGS. 5C-5D). The steering assembly of the dual-axle vehicle corner system may cause and/or may be controlled by the test rig to cause at least one of the first wheel and the second wheel to steer about their respective steering axes during actuating of the suspension assembly (e.g., as described above with respect to FIGS. 5A-5D).

Based on signals from at least one of sensors of the dual-axle vehicle corner system or sensors of the test rig, it may be determined by a computing device (e.g., such as computing devices 140, 240, 350, 450, 540 described hereinabove) whether or not subsystems of the dual-axle vehicle corner system are at least one of tuned and operate according to predefined specifications (e.g., as described above with respect to FIGS. 1A-1C, 2A-2B, 3A-3B, 4A-4B and 5A-5D). By the computing device, the sensors of the of the dual-axle vehicle corner system may be calibrated based on signals from the sensors of the test rig (e.g., as described above with respect to FIGS. 1A-1C. 2A-2B, 3A-3B, 4A-4B and 5A-5D).

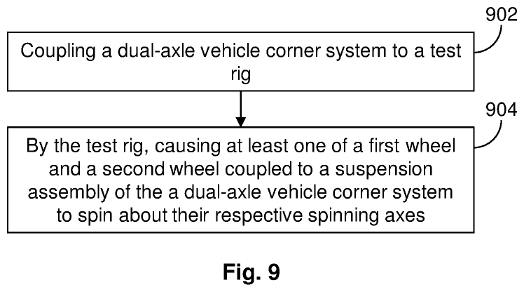

Reference is made to FIG. 9, which is a flowchart of a method of testing a dual-axle vehicle corner system including a drivetrain assembly, according to some embodiments of the invention.

The operations described with respect to FIG. 9 may be performed using test rigs 100, 200, 300, 400, 500, 600 described hereinabove and/or any other suitable equipment.

In operation 902, a dual-axle vehicle corner system (e.g., dual-axle vehicle corner system 90 described hereinabove) may be coupled to a test rig (e.g., test rig 100, 200, 300, 400, 500, 600 described hereinabove). For example, a sub-frame (e.g., sub-frame 93 described hereinabove) and/or any other suitable component of the dual-axle vehicle corner system may be coupled (e.g., rigidly or with one or more degrees of freedom) to a support frame (e.g., support frame 105 described hereinabove) of the test rig (e.g., as described hereinabove).

In operation 904, a first wheel and/or a second wheel coupled to a suspension assembly of the dual-axle vehicle corner system may be caused, by the test rig, to spin about their respective spinning axes. For example, the test rig may rotate at least one rotatable member supporting the first wheel and/or the second wheel (e.g., rotatable members 310, 312 described above with respect to FIGS. 3A-3B and/or rotatable members 410, 412 described above with respect to FIGS. 4A-4B) to cause the first wheel and/or the second wheel to spin.

A first braking actuator and/or a second braking actuator of the dual-axle vehicle corner system (e.g., such as barking actuators 91a, 92a described above with respect to FIGS. 3A-3B and 4A-4B) may be controlled by the test rig. For example, the first braking actuator and/or the second braking actuator may be actuated by the test rig, for example to resist the spinning of the first wheel and/or the spinning of the second wheel caused by the test rig. Actuation of the first braking actuator and/or of the second braking actuator while the first wheel and/or the second wheel are caused to spin by the test rig may allow testing the first braking actuator and/or the second braking actuator of the dual-axle vehicle corner system.

A suspension assembly (e.g., suspension assembly 94 described hereinabove) of the dual-axle vehicle corner system may be repeatedly actuated by the test rig in a vertical direction, wherein the vertical direction may be perpendicular to spinning axes of the first wheel (e.g., first wheel 91 described hereinabove) and the second wheel (e.g., second wheel 92 described hereinabove) coupled the suspension assembly.

The suspension assembly may be actuated by repeatedly causing motion of at least one of the first wheel and the second wheel in the vertical direction with respect to the sub-frame of the dual-axle vehicle corner system (e.g., as described above with respect to FIGS. 1A-1C). For example, the first wheel and/or the second wheel may be moved in the vertical direction by moving at least one wheel support surface of the test rig in the vertical direction (e.g., wheel support surface 110 as described above with respect to FIGS. 1A-1B or first wheel support surface 112 and second wheel support surface 114 as described above with respect to FIG. 1C).

The suspension assembly may be actuated by repeatedly causing motion of the sub-frame of the dual-axle vehicle corner system with respect to at least one of the first wheel and the second wheel in the vertical direction (e.g., as described above with respect to FIGS. 2A-2B). For example, the sub-frame may be moved in the vertical direction by moving the support frame of the test rig in the vertical direction (e.g., as described above with respect to FIGS. 2A-2B).

The suspension assembly may be actuated by repeatedly causing motion of at least one of the first wheel, the second wheel and the sub-frame of the dual-axle vehicle corner system in directions that are transverse to the vertical direction, for by moving the at least one wheel support and/or the support frame of the test rig in directions that are transverse to the vertical direction (e.g., as described above with respect to FIGS. 1A-1C and FIGS. 2A-2B).

The suspension assembly may be actuated by inclining the support frame of the test rig coupled to the sub-frame of the dual-axle vehicle corner system with respect to the at least one wheel support surface of the test rig supporting the first wheel and the second wheel (e.g., as described above with respect to FIGS. 1A-1C and FIGS. 2A-2B). The inclination may be about an axis that is substantially transverse to the spinning axes of the first wheel and the second wheel and/or about an axis that is substantially parallel to the spinning axes of the first wheel and the second wheel (e.g., as described above with respect to FIGS. 1A-1C and FIGS. 2A-2B).

The weight of the dual-axle vehicle corner system may be adjusted by coupling a plurality of weights (e.g., such as weights 107 described above with respect to FIGS. 1A-1C) to the dual-axle vehicle corner system. The coupling of the plurality of weights may be to a component of the test rig to which the dual-axle vehicle corner system is coupled, for example to the support frame of the test rig (e.g., as described above with respect to the FIGS. 1A-1C and FIGS. 2A-2B).

A steering assembly (e.g., steering assembly 98 described hereinabove) of the dual-axle vehicle corner system by be actuated by the test rig by causing the first wheel, the second wheel or both to repeatedly rotate about their respective steering axes that are substantially parallel to the spinning axes of the first wheel and the second wheel (e.g., using rotatable wheel support surface 510 as described above with respect to FIGS. 5A-5B or rotatable wheel support surfaces 512, 514 as described above with respect to FIGS. 5C-5D). The steering assembly of the dual-axle vehicle corner system may cause and/or may be controlled by the test rig to cause at least one of the first wheel and the second wheel to steer about their respective steering axes during actuating of the suspension assembly (e.g., as described above with respect to FIGS. 5A-5D).

Based on signals from at least one of sensors of the dual-axle vehicle corner system or sensors of the test rig, it may be determined by a computing device (e.g., such as computing devices 140, 240, 350, 450, 540 described hereinabove) whether or not subsystems of the dual-axle vehicle corner system are at least one of tuned and operate according to predefined specifications (e.g., as described above with respect to FIGS. 1A-1C, 2A-2B, 3A-3B, 4A-4B and 5A-5D). By the computing device, the sensors of the of the dual-axle vehicle corner system may be calibrated based on signals from the sensors of the test rig (e.g., as described above with respect to FIGS. 1A-1C. 2A-2B, 3A-3B, 4A-4B and 5A-5D).

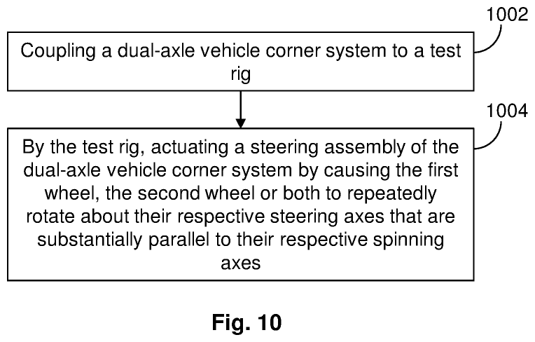

Reference is now made to FIG. 10, which is a flowchart of a method of testing a dual-axle vehicle corner system including a steering assembly, according to some embodiments of the invention.

The operations described with respect to FIG. 10 may be performed using test rigs 100, 200, 300, 400, 500, 600 described hereinabove and/or any other suitable equipment. In operation 1002, a dual-axle vehicle corner system (e.g., dual-axle vehicle corner system 90 described hereinabove) may be coupled to a test rig (e.g., test rig 100, 200, 300, 400, 500, 600 described hereinabove). For example, a sub-frame (e.g., sub-frame 93 described hereinabove) and/or any other suitable component of the dual-axle vehicle corner system may be coupled (e.g., rigidly or with one or more degrees of freedom) to a support frame (e.g., support frame 105 described hereinabove) of the test rig (e.g., as described hereinabove).

In operation 1004, a steering assembly (e.g., steering assembly 98 described hereinabove) of the dual-axle vehicle corner system may be actuated by the test rig by causing a first wheel, a second wheel or both to repeatedly rotate about their respective steering axes that are substantially parallel to their respective spinning axes (e.g., using rotatable wheel support surface 510 as described above with respect to FIGS. 5A-5B or rotatable wheel support surfaces 512, 514 as described above with respect to FIGS. 5C-5D).

The suspension assembly (e.g., suspension assembly 94 described hereinabove) of the dual-axle vehicle corner system may be repeatedly actuated by the test rig in a vertical direction, wherein the vertical direction may be perpendicular to spinning axes of the first wheel (e.g., first wheel 91 described hereinabove) and the second wheel (e.g., second wheel 92 described hereinabove) coupled the suspension assembly.

The suspension assembly may be actuated by repeatedly causing motion of at least one of the first wheel and the second wheel in the vertical direction with respect to the sub-frame of the dual-axle vehicle corner system (e.g., as described above with respect to FIGS. 1A-1C). For example, the first wheel and/or the second wheel may be moved in the vertical direction by moving at least one wheel support surface of the test rig in the vertical direction (e.g., wheel support surface 110 as described above with respect to FIGS. 1A-1B or first wheel support surface 112 and second wheel support surface 114 as described above with respect to FIG. 1C).

The suspension assembly may be actuated by repeatedly causing motion of the sub-frame of the dual-axle vehicle corner system with respect to at least one of the first wheel and the second wheel in the vertical direction (e.g., as described above with respect to FIGS. 2A-2B). For example, the sub-frame may be moved in the vertical direction by moving the support frame of the test rig in the vertical direction (e.g., as described above with respect to FIGS. 2A-2B).

The suspension assembly may be actuated by repeatedly causing motion of at least one of the first wheel, the second wheel and the sub-frame of the dual-axle vehicle corner system in directions that are transverse to the vertical direction, for by moving the at least one wheel support and/or the support frame of the test rig in directions that are transverse to the vertical direction (e.g., as described above with respect to FIGS. 1A-1C and FIGS. 2A-2B).

The suspension assembly may be actuated by inclining the support frame of the test rig coupled to the sub-frame of the dual-axle vehicle corner system with respect to the at least one wheel support surface of the test rig supporting the first wheel and the second wheel (e.g., as described above with respect to FIGS. 1A-1C and FIGS. 2A-2B). The inclination may be about an axis that is substantially transverse to the spinning axes of the first wheel and the second wheel and/or about an axis that is substantially parallel to the spinning axes of the first wheel and the second wheel (e.g., as described above with respect to FIGS. 1A-1C and FIGS. 2A-2B).

The weight of the dual-axle vehicle corner system may be adjusted by coupling a plurality of weights (e.g., such as weights 107 described above with respect to FIGS. 1A-1C) to the dual-axle vehicle corner system. The coupling of the plurality of weights may be to a component of the test rig to which the dual-axle vehicle corner system is coupled, for example to the support frame of the test rig (e.g., as described above with respect to the FIGS. 1A-1C and FIGS. 2A-2B).

The first wheel and/or the second wheel coupled to the suspension assembly of the dual-axle vehicle corner system may be caused, by the test rig, to spin about their respective spinning axes. For example, the test rig may rotate at least one rotatable member supporting the first wheel and/or the second wheel (e.g., rotatable members 310, 312 described above with respect to FIGS. 3A-3B and/or rotatable members 410, 412 described above with respect to FIGS. 4A-4B) to cause the first wheel and/or the second wheel to spin.

A powertrain assembly (e.g., such as powertrain assembly 96 described here above) of the dual-axle vehicle corner system, may cause and/or may be controlled by the test rig to cause at least one of the first wheel and the second wheel to spin. The operation of the powertrain assembly may be resisted by the test rig by applying a rotational force on at least one of the first wheel and the second wheel in a direction that is opposite to direction of spinning of the first wheel and the second wheel, for example by at least one rotatable member 410, 412 supporting the first wheel and the second wheel (e.g., as described above with respect to FIGS. 4A-4B).

Based on signals from at least one of sensors of the dual-axle vehicle corner system or sensors of the test rig, it may be determined by a computing device (e.g., such as computing devices 140, 240, 350, 450, 540 described hereinabove) whether or not subsystems of the dual-axle vehicle corner system are at least one of tuned and operate according to predefined specifications (e.g., as described above with respect to FIGS. 1A-1C, 2A-2B, 3A-3B, 4A-4B and 5A-5D). By the computing device, the sensors of the of the dual-axle vehicle corner system may be calibrated based on signals from the sensors of the test rig (e.g., as described above with respect to FIGS. 1A-1C, 2A-2B, 3A-3B, 4A-4B and 5A-5D).

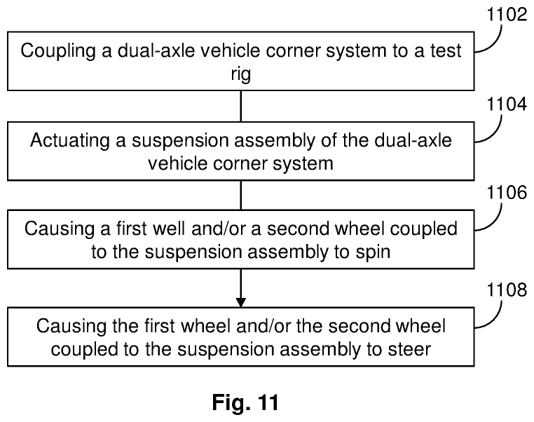

Reference is now made to FIG. 11, which is a flowchart of a method of testing a dual-axle vehicle corner system, according to some embodiments of the invention.

The operations described with respect to FIG. 11 may be performed using test rigs 100. 200, 300, 400, 500, 600 described hereinabove and/or any other suitable equipment.

The operations described with respect to FIG. 11 need not move through each illustrated box or state, or in exactly the same order as illustrated and described. For example, one or more of the operations may be performed. In another example, two or more operations may be performed, simultaneously or in any suitable order.

In operation 1102, a dual-axle vehicle corner system (e.g., dual-axle vehicle corner system 90 described hereinabove) may be coupled to a test rig (e.g., test rig 100, 200, 300, 400, 500, 600 described hereinabove). For example, a sub-frame (e.g., sub-frame 93 described hereinabove) and/or any other suitable component of the dual-axle vehicle corner system may be coupled (e.g., rigidly or with one or more degrees of freedom) to a support frame (e.g., support frame 105 described hereinabove) of the test rig (e.g., as described hereinabove).

In operation 1104, a suspension assembly (e.g., suspension assembly 94 described hereinabove) of the dual-axle vehicle corner system may be actuated.

The suspension assembly may be actuated by the test rig. The suspension assembly may be repeatedly actuated by the test rig in at least one of a vertical direction and directions that are transverse to the vertical direction, wherein the vertical direction may be perpendicular to spinning axes of a first wheel (e.g., first wheel 91 described hereinabove) and a second wheel (e.g., second wheel 92 described hereinabove) coupled the suspension assembly (e.g., as described hereinabove).

The suspension assembly may be actuated by repeatedly causing motion of the sub-frame of the dual-axle vehicle corner system with respect to at least one of the first wheel and the second wheel in the vertical direction (e.g., as described above with respect to FIGS. 2A-2B). For example, the sub-frame may be moved in the vertical direction by moving the support frame of the test rig in the vertical direction (e.g., as described above with respect to FIGS. 2A-2B).

The suspension assembly may be actuated by repeatedly causing motion of at least one of the first wheel, the second wheel and the sub-frame of the dual-axle vehicle corner system in directions that are transverse to the vertical direction, for by moving the at least one wheel support and/or the support frame of the test rig in directions that are transverse to the vertical direction (e.g., as described above with respect to FIGS. 1A-1C and FIGS. 2A-2B).

The suspension assembly may be actuated by inclining the support frame of the test rig coupled to the sub-frame of the dual-axle vehicle corner system with respect to the at least one wheel support surface of the test rig supporting the first wheel and the second wheel (e.g., as described above with respect to FIGS. 1A-1C and FIGS. 2A-2B). The inclination may be about an axis that is substantially transverse to the spinning axes of the first wheel and the second wheel and/or about an axis that is substantially parallel to the spinning axes of the first wheel and the second wheel (e.g., as described above with respect to FIGS. 1A-1C and FIGS. 2A-2B).

The distance between the first wheel and the second wheel may be changed. For example, the distance between the first wheel and the second wheel may be changed by the test rig (e.g., by increasing the distance between the wheel supports 112, 114 as described above with respect to FIG. 1C). In another example, the distance between the first wheel and the second wheel may be changed by the suspension assembly of the dual-axle vehicle corner system (e.g., as described above with respect to FIGS. 1A-1C).

In operation 1106, the first wheel and/or the second wheel coupled to the suspension assembly of the dual-axle vehicle corner system may be caused to spin about their respective spinning axes.

The first wheel and/or the second wheel may be caused to spin by the test rig. For example, the test rig may rotate at least one rotatable member supporting the first wheel and/or the second wheel (e.g., rotatable members 310, 312 described above with respect to FIGS. 3A-3B and/or rotatable members 410, 412 described above with respect to FIGS. 4A-4B) to cause the first wheel and/or the second wheel to spin.

The first wheel and/or the second wheel may be caused to spin by a powertrain assembly of the dual-axle vehicle corner system (e.g., such as powertrain assembly 96 described here above). For example, the powertrain assembly may cause and/or may be controlled by the test rig to cause at least one of the first wheel and the second wheel to spin. The operation of the powertrain assembly may be resisted by the test rig by applying a rotational force on at least one of the first wheel and the second wheel in a direction that is opposite to direction of spinning of the first wheel and the second wheel, for example by at least one rotatable member 410, 412 supporting the first wheel and the second wheel (e.g., as described above with respect to FIGS. 4A-4B).

In operation 1108, the first wheel and/or the second wheel coupled to the suspension assembly of the dual-axle vehicle corner system may be caused to steer about their respective steering axes.

The first wheel and/or the second wheel may be caused to steer by the test rig, for example using rotatable wheel support surface 510 as described above with respect to FIGS. 5A-5B or rotatable wheel support surfaces 512, 514 as described above with respect to FIGS. 5C-5D.

The first wheel and/or the second wheel may be caused to steer by a steering assembly of the dual-axle vehicle corner system. For example, the steering assembly of the dual-axle vehicle corner system may cause and/or may be controlled by the test rig to cause at least one of the first wheel and the second wheel to steer about their respective steering axes.

In the above description, an embodiment is an example or implementation of the invention. The various appearances of “one embodiment”, “an embodiment”, “certain embodiments” or “some embodiments” do not necessarily all refer to the same embodiments. Although various features of the invention can be described in the context of a single embodiment, the features can also be provided separately or in any suitable combination. Conversely, although the invention can be described herein in the context of separate embodiments for clarity, the invention can also be implemented in a single embodiment. Certain embodiments of the invention can include features from different embodiments disclosed above, and certain embodiments can incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1-22. (canceled)

23. A test rig or a dual-axle vehicle corner system comprising a suspension assembly and a first wheel and a second wheel coupled to the suspension assembly, the test rig comprising:
a support frame to couple the dual-axle vehicle corner system to the test rig;
a wheel support surface to support the first wheel and the second wheel of the dual-axle vehicle corner system; and
at least one actuator to repeatedly move the support frame in a direction that is substantially perpendicular to the wheel support surface to actuate the suspension assembly of the dual-axle vehicle corner system.

24. The test rig of claim 23, wherein the at least one actuator is to at least one of:
repeatedly move the support frame in a direction that is substantially perpendicular to the support frame and substantially parallel to the wheels support surface, and
repeatedly move the support frame in a direction that is substantially parallel to the support frame and to the wheels support surface.

25. (canceled)

26. The test rig of claim 23, wherein the at least one actuator is to at least one of:
incline the support frame about an axis being parallel to a direction that is substantially perpendicular to the support frame and substantially parallel to the wheels support surface, and
incline the support frame about an axis being parallel to a direction that is substantially parallel to the support frame and to the wheels support surface.

27. (canceled)

28. The test rig of claim 23, comprising a reference frame, wherein the frame is coupled to the reference frame and is slidable with respect to the reference frame in one or more directions.

29. (canceled)

30. The test rig of claim 23, comprising at least one rotatable member mounted within the at least one wheel support surface, the at least one rotatable member is to support the first wheel and the second wheel of the dual-axle vehicle corner system while the first wheel and the second wheel are spinning.

31. The test rig of claim 30, comprising at least one motor to rotate the at least one rotatable member in a direction that is opposite to direction of rotation of the first wheel and the second wheel to resist operation of a powertrain assembly of the dual-axle vehicle corner system.

32. The test rig of claim 30, comprising at least one motor to rotate the at least one rotatable member to cause the first wheel and the second wheel the dual-axle vehicle corner system to spin.

33. The test rig of claim 23, wherein the at least one wheel support surface is rotatable about a rotation axis that is substantially perpendicular to the at least one wheel support surface, and the test rig comprises at least one motor to rotate the at least one wheel support surface.

34. The test rig of claim 23, comprising a computing device to, based on signals from at least one of sensors of the dual-axle vehicle corner system or sensors of the test rig, determine whether or not subsystems of the dual-axle vehicle corner system are at least one of tuned and operate according to predefined specifications.

35. The test rig of claim 34, wherein the computing device to calibrate the sensors of the of the dual-axle vehicle corner system based on signals from the sensors of the test rig.

36. The test rig of claim 23, comprising a computing device to control a steering assembly of the dual-axle vehicle corner system to cause at least one of the first wheel and the second wheel to steer about their respective steering axes during actuating of the suspension assembly.

37-57. (canceled)

58. A method of testing a dual-axle vehicle corner system comprising a suspension assembly and a first wheel and a second wheel coupled to the suspension assembly, the method comprising:
coupling the dual-axle vehicle corner system to a test rig; and
by the test rig, repeatedly actuating the suspension assembly of the dual-axle vehicle corner system a vertical direction, the vertical direction being perpendicular to spinning axes of the first wheel and the second wheel coupled the suspension assembly; and
wherein the actuating of the suspension assembly is by causing motion of a sub-frame of the dual-axle vehicle corner system with respect to at least one of the first wheel and the second wheel in the vertical direction.

59. The method of claim 58, wherein the actuating of the suspension assembly is by repeatedly causing motion of at least one of the first wheel and the second wheel in the vertical direction with respect to a sub-frame of the dual-axle vehicle corner system.

60. (canceled)

61. The method of claim 58, wherein the actuating of the suspension assembly is further by repeatedly causing motion of at least one of the first wheel, the second wheel and a sub-frame of the dual-axle vehicle corner system in directions that are transverse to the vertical direction.

62. The method of claim 58, wherein the actuating of the suspension assembly is further by inclining a support frame of the test rig coupled to the dual-axle vehicle corner system with respect to at least one wheel support surface of the test rig supporting the first wheel and the second wheel.

63-67. (canceled)

68. The method of claim 58, comprising:
by the test rig, controlling a powertrain assembly of the dual-axle vehicle corner system to cause at least one of the first wheel and the second wheel to spin; and
by the test rig, resisting operation of the powertrain assembly by applying a rotational force on at least one of the first wheel and the second wheel in a direction that is opposite to direction of spinning of the first wheel and the second wheel.

69. The method of claim 58, comprising, by the test rig, actuating a steering assembly of the dual-axle vehicle corner system by causing the first wheel, the second wheel or both to repeatedly rotate about their respective steering axes that are substantially parallel to the spinning axes of the first wheel and the second wheel.

70. The method of claim 58, comprising:
by the test rig, controlling a steering assembly of the dual-axle vehicle corner system to cause at least one of the first wheel and the second wheel to steer about their respective steering axes during actuating of the suspension assembly.

71. The method of claim 58, comprising, by a computing device, based on signals from at least one of sensors of the dual-axle vehicle corner system or sensors of the test rig, determining whether or not subsystems of the dual-axle vehicle corner system are at least one of tuned and operate according to predefined specifications.

72. The method of claim 71, comprising, by the computing device, calibrating the sensors of the of the dual-axle vehicle corner system based on signals from the sensors of the test rig.

73-97. (canceled)
